(19) United States
(12) Patent Application Publication
(10) Pub. No.: US 2026/0064865 A1
(43) Pub. Date: Mar. 5, 2026

(54) DATA ANALYTICS SYSTEMS WITH EFFECTIVE ACCESS PERMISSION MONITORING

(71) Applicant: Nutanix, Inc., San Jose, CA (US)

(72) Inventors: Ketan Kotwal, Pune (IN); Paresh Lohakare, Pune (IN); Tushar Dnyandev Adivarekar, Pune (IN); Aarti Walimbe, Pune (IN)

(73) Assignee: Nutanix, Inc., San Jose, CA (US)

(21) Appl. No.: 19/076,847

(22) Filed: Mar. 11, 2025

(30) Foreign Application Priority Data
Aug. 30, 2024 (IN) 202411065671

(51) Int. Cl. G06F 21/60; G06F 16/188; G06F 21/62

(52) U.S. Cl. CPC G06F 21/604; G06F 16/188; G06F 21/6227

(57) ABSTRACT

Data analytics methods are described herein which may provide permission management to one or more file servers in a virtualized file system. Example methods may include receiving, at an analytics system, an access control list of a storage item in a file server responsive to a change to data in the storage item, the access control list including access control entries; evaluating effective access of the access control list based on an active directory; detecting a change in either one or more permissions or one or more memberships of the storage item in the active directory; re-evaluating, at the analytics system, the effective permission of the access control list upon detecting the change; storing the effective permission in a data repository of the analytics system; and accessing the effective permission at the data repository during a time the file server is unavailable to the analytics system.

### CROSS-REFERENCE TO RELATED APPLICATION(S)

This application claims priority to India Provisional Application No. 202411065671, filed Aug. 30, 2024, which is incorporated herein by reference, in its entirety, for any purpose.

### TECHNICAL FIELD

Examples described herein relate to data analytics systems for file systems, including distributed file servers hosting file systems. Examples of analytics systems which may collect effective permission information as updated across the distributed file servers are described herein.

### BACKGROUND

Data, including files, are increasingly important to enterprises and individuals. The ability to store significant corpuses of files is important to the operation of many modern enterprises. Existing systems that store enterprise data may be complex or cumbersome to interact with to quickly or easily establish what actions have been taken with respect to the enterprise's data and what attention may be needed from an administrator.

In addition, without current effective permission information of the file system updated from time to time that may indicate risks of fraudulent accesses to the enterprise data, it may be difficult to determine usage characteristics and to detect anomalies.

Often, one or more file systems or file servers may be transitioned to an offline state. For example, after an anomaly is detected, such as a ransomware attack or other potentially malicious activity, access to the file system or file server may be limited or curtailed to limit additional damage. During times when the access to the file system or file server is limited or curtailed, it may be difficult to obtain accurate forensic information about the file system or file server because queries to the distributed file servers may not be accepted and/or answered.

### BRIEF DESCRIPTION OF THE DRAWINGS

FIG. 1A is a schematic illustration of a distributed computing system hosting a virtualized file server arranged in accordance with examples described herein.

FIG. 1B is a schematic illustration of the distributed computing system of FIG. 1A showing a failover of a failed file server virtual machine (FSVM) in accordance with examples described herein.

FIG. 2 is a schematic illustration of an analytics system in communication with a file server arranged in accordance with examples described herein.

FIG. 3 is a communication flow diagram illustrating a method of monitoring effective access permission in accordance with examples described herein.

FIG. 4 is a schematic illustration of an analytics system in accordance with examples described herein.

FIG. 5 is a flowchart of a method 500 for evaluating access control lists (ACLs) into effective permissions in accordance with examples described herein.

FIGS. 6A-6B are schematic illustrations of an example user interface display which may be generated in part by analytics systems described herein.

FIGS. 7A-7B are schematic illustrations of an example user interface display which may be generated in part by analytics systems described herein.

FIG. 8 is a schematic illustration of components of a computing node (e.g., computing device or computing system) in accordance with embodiments of the present disclosure.

### DETAILED DESCRIPTION

Certain details are set forth herein to provide an understanding of described embodiments of technology. However, other examples may be practiced without various of these particular details. In some instances, well-known circuits, control signals, timing protocols, and/or software operations have not been shown in detail in order to avoid unnecessarily obscuring the described embodiments. Other embodiments may be utilized, and other changes may be made, without departing from the spirit or scope of the subject matter presented here.

Data analytics systems described herein may provide a cloud-hosted analytics and monitoring service for file servers. The file servers may be hosted on any number of architectures, such as Nutanix Files and/or Isilon and/or NetApp file servers. Data analytics systems described herein may centralize data from clusters connected to admin systems operating at various data center locations. Cloud resources may reduce scaling constraints, as the cloud is not dependent on the file server resources, which may provide near-real-time analytics and alerts even for load-heavy file servers of more than 250 million files and over 500 TB of storage. Hosting file analytics on premises may limit the service to local file servers only. In contrast, systems described herein may function on a global level, in a cluster-neutral environment, without being tied to a single cluster.

Examples described herein include metadata and events-based file analytics systems for file systems. In some examples, the file systems may be implemented using hyper-converged scale out distributed file storage systems. Embodiments presented herein include a file analytics system which may retrieve, organize, aggregate, and/or analyze information pertaining to a file system. Information about the file system may be stored in a data repository, such as an analytics datastore. The file analytics system may query or monitor the analytics datastore to provide information (e.g., to an administrator) in the form of display interfaces, reports, and alerts and/or notifications. In some examples, the file analytics system may be hosted in a remote computing environment (e.g., in a cloud computing architecture). In some examples, the file analytics system may be hosted on a computing node, whether standalone or on a cluster of computing nodes. In some examples, the file analytics system may interface with a file system managed by a distributed virtualized file server (VFS) hosted on a cluster of computing nodes. An example VFS may provide for shared storage (e.g., across an enterprise), failover and backup functionalities, as well as scalability and security of data stored on the VFS.

Data analytics systems described herein may scan metadata from the file system, and/or receive event data from the file system, and may store the metadata and/or event data in a database, data warehouse, or other location. This data may be used to provide a variety of analytics for the file system. During operation, the file analytics system may retrieve metadata associated with the file system, configuration and/or user information from the file system, and/or event data from the file system.

In some examples, the file server may include an audit framework that manages event data in an event log. The audit framework may be configured to communicate with the analytics system to provide event data and/or metadata to the analytics system from the event log.

In some examples, the information retrieved or received by the analytics system may include event data records and metadata. The metadata collection process may include gathering the overall size, structure, and storage locations of parts of the file system managed by the file server, as well as details (e.g., file size, allocated storage quota, creation and/or modification information, owner information, permissions information, etc.) for each data item (e.g., file, folder, directory, share, etc.) in the file system. In some examples, the metadata collection process may rely on scanning one or more snapshots of the file system managed by the file server to gather the metadata, such as one or more snapshots generated by a disaster recovery application of the file server. The analytics tool may use the information gathered from the one or more snapshots to develop a comprehensive picture of the file system managed by the file server. In some examples, the analytics tool may employ multiple threads to perform scanning of the snapshots in parallel. The multiple threads may be employed to scan different shares in parallel, different files of a common share in parallel, or any combination thereof.

To capture configuration information, the file analytics system may use an application programming interface (API) architecture to request the configuration information. The configuration information may include user information, a number of shares, deleted shares, created shares, etc.

To capture event data, the VFS may include an audit framework with a connector that is configured to communicate the event data records and other information for consumption by a file analytics system. The event data records may include data related to various operations on the file system executed by the VFS, such as adding, deleting, moving, modifying, etc., a file, folder, directory, share, etc. The event data records may indicate an event type (e.g., add, move, delete, modify, a user associated with the event, an event time, etc.).

To capture event data, the file analytics system may interface with the file server to receive event data. Received event data may be stored by the file analytics system in an analytics datastore, which may be a database and/or data warehouse. The event data may include data related to various operations performed with the file system, such as creating, deleting, reading, opening, editing, moving, modifying, etc., a file, folder, directory, share, etc., within the file system. The event information may indicate an event type (e.g., create, read, edit, delete), a user associated with the event, an event time, etc. Examples of events which may be supported in some examples include file open, file write, file rename, file create, file read, file delete, security change, directory create, directory delete, file open/permission denied, file close, and/or set attribute. Events may include file server audit events (e.g., Server Message Block (SMB) audit events). Events as described herein may be for either a file, directory, share, or other item of the file server.

Examples of analytics systems described herein may provide a user interface indicating permission management of access to storage items (e.g., shares, directories, files) in the server (e.g., SMB) environment. In these systems, the permission management may be based on access control lists (ACLs). Data analytics systems described herein may utilize the metadata and event data to provide the ACLs. Each ACL in a share includes one or more access control entries (ACEs) where each ACE indicates a level of access that a security principal (e.g., user or group) in that entry has. To get the memberships of the user/group, an/the active directory may be accessed. Such permission management may be performed without access to a file server. For example, the permission management may be performed at and/or by a data analytics system which may maintain audit records and/or metadata records relating to the file server. During times when the file server is unavailable, the data analytics system may continue to respond to requests for information regarding the file server.

An example system may include a data model and user interface. Examples of analytics systems are described which may receive ACLs including ACEs from a file server as part of scan and audit events when there are changes to data. The data model stores ACL-related information. The data model may process a query. In some examples, the data model may return directories that a given user or a list of users has access to based on the given user or the list of users in the query. In some examples, the data model may return users that have access to a directory or a list of directories based on the given directory or list of directories in the query. In some examples, the data model may return groups that have access to a directory or list of directories based on the given directory or list of directories in the query.

Inline evaluation of effective access in ACLs may be performed by default. An ACL for each directory is immediately evaluated as part of the data pipeline itself. This allows the user to view effective permissions for all users/groups in the ACL in a single view without having to calculate it each time separately. Next, re-evaluation of effective permissions may be performed upon any change in permissions or change in user/group memberships. Any change in the ACL on the share or any change of user/group membership in an active directory is likely to change the effective permissions in the ACL. This change is automatically identified and updated through re-evaluation of the ACL. Then evaluation without an active connection may be performed with either the share or the active directory. Because the evaluation of the ACL is performed as part of the data pipeline away from the actual share or active directory, the effective permission evaluation does not require any active connection to either the share or the active directory. The evaluation processes may be performed by the data model and the effective ACLs may be presented using the user interface.

The file analytics system may generate reports, including predetermined reports and/or customizable reports. The reports may be related to aggregate and/or specific user activity; aggregate file system activity; specific file, directory, share, etc., activity; or any combination thereof.

Examples described herein provide analytics which may be used, for example, to collect, analyze, and display data about a file system. Generally, data from any file system may be obtained and analyzed in accordance with techniques described herein. In some examples, the file system may be implemented as a virtualized file system, such as on a distributed virtualized file server which may host a file system. Virtualization may be advantageous in modern business and computing environments in part because of the resource utilization advantages provided by virtualized computing systems. Without virtualization, if a physical machine is limited to a single dedicated process, function, and/or operating system, then during periods of inactivity by that process, function, and/or operating system, the physical machine is not utilized to perform useful work. This may be wasteful and inefficient if there are users on other physical machines which are currently waiting for computing resources. To address this problem, virtualization allows multiple virtualized computing instances, such as virtual machines (VMs) and/or containers to share the underlying physical resources so that during periods of inactivity by one virtualized computing instance, other instances can take advantage of the resource availability to process workloads. This can produce efficiencies for the utilization of physical devices and can result in reduced redundancies and better resource cost management.

Furthermore, virtualized computing systems may be used to not only utilize the processing power of the physical devices but also to aggregate the storage of the individual physical devices to create a logical storage pool where the data may be distributed across the physical devices but appears to the virtual machines and/or containers to be part of the system that the virtual machine and/or container is hosted on. Such systems may operate using metadata, which may be distributed and replicated any number of times across the system, to locate the indicated data.

Examples of virtualized file servers that may be used in examples described herein are also described in U.S. Published Patent Application 2017/0235760, published Aug. 17, 2017, entitled “Virtualized File Server” on U.S. application Ser. No. 15/422,220 filed Feb. 1, 2017, which application and publication are hereby incorporated herein by reference in their entirety for any purpose.

Examples of analytics systems which may be integrated with virtualized file servers are also described in U.S. Published Patent Application 2022/0318204, published Oct. 16, 2022, and entitled “File Analytics Systems and Methods” on U.S. application Ser. No. 17/304,096, filed Jun. 14, 2021, and U.S. Published Patent Application 2024/0111733, published Apr. 4, 2024, entitled “Data Analytics Systems for File Systems including Tiering” on U.S. application Ser. No. 18/478,790 filed Sep. 29, 2023, which applications and publications are hereby incorporated by reference herein in their entirety for any purpose.

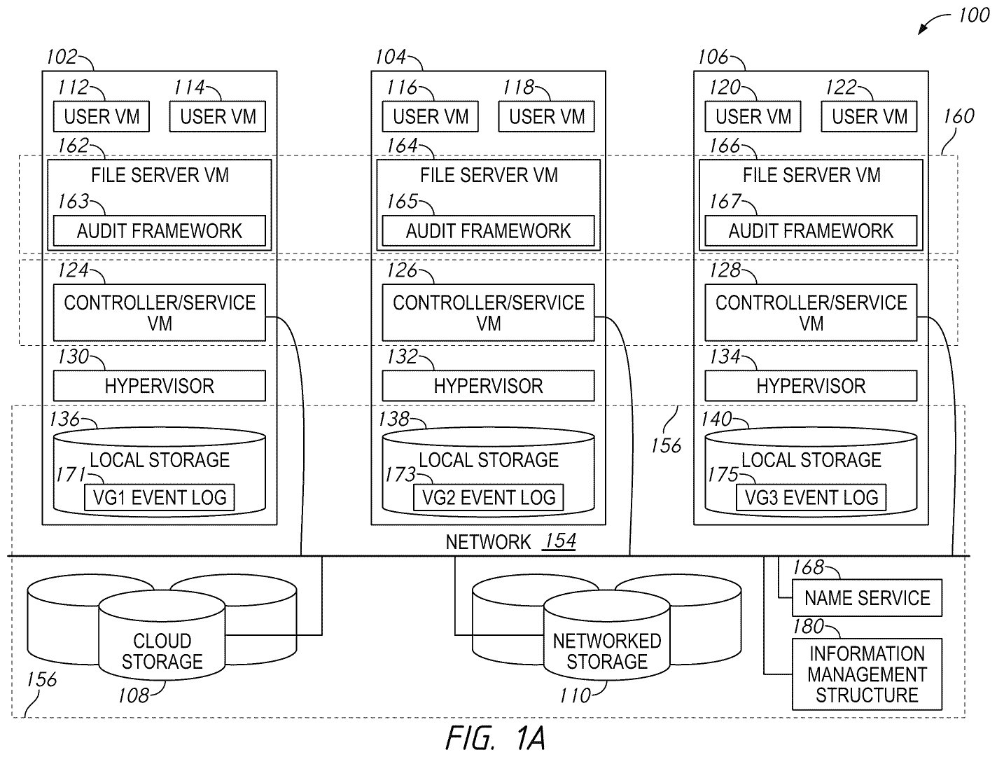

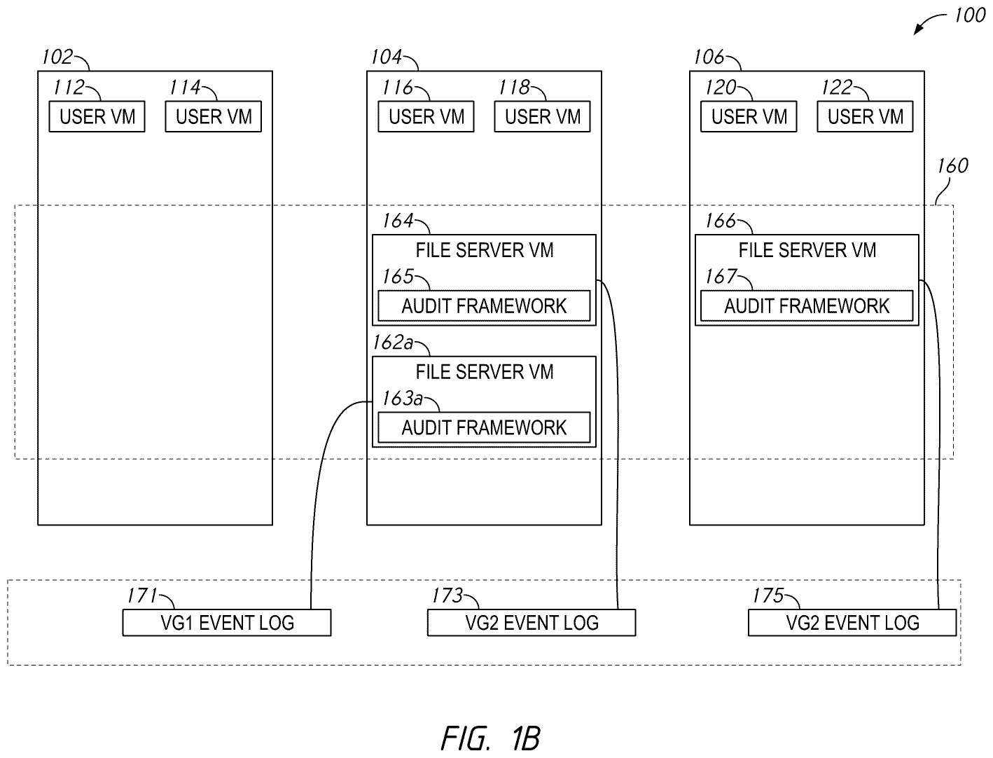

FIG. 1A is a schematic illustration of a distributed computing system hosting a virtualized file server arranged in accordance with examples described herein. The system 100, which may be a virtualized system and/or a clustered virtualized system, includes a virtualized file server (VFS) 160. While shown as a virtual machine, examples of analytics applications may be implemented using one or more virtual computing instances, which may be implemented, for example, as virtual machines, containers, or combinations thereof. In some examples an analytics system, which may include a data repository such as an analytics datastore, may be provided as a hosted solution in one or more cloud computing platforms, which may be in communication with the system 100 of FIG. 1A.

The system of FIG. 1A can be implemented using a distributed computing system. Distributed computing systems generally include multiple computing nodes (e.g., physical computing resources)—see host machines 102, 106, and 104 in FIG. 1A—that may manage shared storage, which may be arranged in multiple tiers. The storage may include storage that is accessible through network 154, such as, by way of example and not limitation, cloud storage 108 (e.g., which may be accessible through the Internet), network-attached storage 110 (NAS) (e.g., which may be accessible through a LAN), or a storage area network (SAN). Examples described herein may also or instead permit local storage 136, 138, and 140 that is incorporated into or directly attached to the host machine and/or appliance to be managed as part of storage pool 156. Accordingly, the storage pool may include local storage of one or more of the computing nodes in the system, storage accessible through a network, or both local storage of one or more of the computing nodes in the system and storage accessible over a network. In some examples, the storage pool 156 may include only the local storage of nodes in the cluster—e.g., local storage 136, 138, and 140. Examples of local storage may include solid state drives (SSDs), hard disk drives (HDDs, and/or “spindle drives”), optical disk drives, external drives (e.g., a storage device connected to a host machine via a native drive interface, or a serial attached SCSI interface), or any other direct-attached storage. These storage devices, both direct-attached and/or network-accessible, collectively form storage pool 156 in some examples. Virtual disks (or “vDisks”) may be structured from the physical storage devices in storage pool 156. A vDisk generally refers to a storage abstraction that is exposed by a component (e.g., a virtual machine, hypervisor, and/or container described herein) to be used by a client (e.g., a user VM, such as user VM 112). In examples described herein, controller VMs—e.g., controller VM 124, 126, and/or 128 of FIG. 1A—may provide access to vDisks. In other examples, access to vDisks may additionally or instead be provided by one or more hypervisors (e.g., hypervisor 130, 132, and/or 134). In some examples, the vDisk may be exposed via iSCSI (“internet small computer system interface”) or NFS (“network file system”) and may be mounted as a virtual disk on the user VM. In some examples, vDisks may be organized into one or more volume groups (VGs).

Each host machine 102, 104, 106 may run virtualization software. Virtualization software may include one or more virtualization managers (e.g., one or more virtual machine managers, such as one or more hypervisors, and/or one or more container managers). Examples of hypervisors include NUTANIX AHV, VMWARE ESX(I), MICROSOFT HYPER-V, DOCKER hypervisor, and REDHAT KVM. Examples of container managers include Kubernetes. The virtualization software shown in FIG. 1A includes hypervisors 130, 132, and 134 which may create, manage, and/or destroy user VMs, as well as manage the interactions between the underlying hardware and user VMs. While hypervisors are shown in FIG. 1A, containers may be used additionally or instead in other examples. User VMs may run one or more applications that may operate as “clients” with respect to other elements within system 100. While shown as virtual machines in FIG. 1A, containers may be used to implement client processes in other examples. Hypervisors may connect to one or more networks, such as network 154 of FIG. 1A, to communicate with storage pool 156 and/or other computing system(s) or components.

In some examples, controller virtual machines, such as CVMs 124, 126, and 128 of FIG. 1A, are used to manage storage and input/output (“I/O”) activities according to particular embodiments. While examples are described herein using CVMs to manage storage I/O activities, in other examples, container managers and/or hypervisors may additionally or instead be used to perform described CVM functionality. The arrangement of virtualization software should be understood to be flexible. In some examples, CVMs act as the storage controller. Multiple such storage controllers may coordinate within a cluster to form a unified storage controller system. CVMs may run as virtual machines on the various host machines, and work together to form a distributed system that manages all the storage resources, including local storage, network-attached storage 110, and cloud storage 108. The CVMs may connect to network 154 directly, or via a hypervisor. Since the CVMs run independent of hypervisors 130, 132, 134, in examples where CVMs provide storage controller functionally, the system may be implemented within any virtual machine architecture since the CVMs of particular embodiments can be used in conjunction with any hypervisor from any virtualization vendor. In other examples, the hypervisor may provide storage controller functionality and/or one or more containers may be used to provide storage controller functionality (e.g., to manage I/O requests to and from the storage pool 156).

A host machine may be designated as a leader node within a cluster of host machines. For example, host machine 104 may be a leader node. A leader node may have a software component designated to perform operations of the leader. For example, CVM 126 on host machine 104 and/or file server VM 164 of host machine 104 may be designated to perform such operations. A leader may be responsible for monitoring or handling requests from other host machines or software components on other host machines throughout the virtualized environment. For example, a leader service may handle the distribution of requests to and from other instances of that service throughout the distributed environment. If a leader fails, a new leader may be designated. In particular embodiments, a management module (e.g., in the form of an agent) may be running on the leader node.

Virtual disks may be made available to one or more user processes. In the example of FIG. 1A, each CVM 124, 126, and 128 may export one or more block devices or NFS server targets that appear as disks to user VMs 112, 114, 116, 118, 120, and 122. These disks are virtual, since they are implemented by the software running inside CVMs 124, 126, and 128. Thus, to user VMs, CVMs appear to be exporting a clustered storage appliance that contains some disks. User data (e.g., including the operating system in some examples) in the user VMs may reside on these virtual disks.

Performance advantages can be gained in some examples by allowing the virtualization system to access and utilize local storage 136, 138, and 140. This is because I/O performance may be much faster when performing access to local storage as compared to performing access to network-attached storage 110 across a network 154. This faster performance for locally attached storage can be increased even further by using certain types of optimized local storage devices, such as SSDs.

As a user process (e.g., a user VM) performs I/O operations (e.g., a read operation or a write operation), the I/O commands may be sent to the hypervisor that shares the same server as the user process, in examples utilizing hypervisors. For example, the hypervisor may present to the virtual machines an emulated storage controller, receive an I/O command, and facilitate the performance of the I/O command (e.g., via interfacing with storage that is the object of the command, or passing the command to a service that will perform the I/O command). An emulated storage controller may facilitate I/O operations between a user VM and a vDisk. A vDisk may present to a user VM as one or more discrete storage drives, but each vDisk may correspond to any part of one or more drives within storage pool 156. Additionally or alternatively, CVMs 124, 126, 128 may present an emulated storage controller either to the hypervisor or to user VMs to facilitate I/O operations. CVMs 124, 126, and 128 may be connected to storage within storage pool 156. CVM 124 may have the ability to perform I/O operations using local storage 136 within the same host machine 102, by connecting via network 154 to cloud storage 108 or network-attached storage 110, or by connecting via network 154 to local storage 138 or 140 within another host machine 104 or 106 (e.g., via connecting to another CVM 126 or 128). In particular embodiments, any computing system may be used to implement a host machine.

Examples described herein include virtualized file servers. A virtualized file server may be implemented using a cluster of virtualized software instances (e.g., a cluster of file server virtual machines). A virtualized file server 160 is shown in FIG. 1A including a cluster of file server virtual machines. The file server virtual machines may additionally or instead be implemented using containers. In some examples, the VFS 160 provides file services to user VMs 112, 114, 116, 118, 120, and 122. The file services may include storing and retrieving data persistently, reliably, and/or efficiently in some examples. The user virtual machines may execute user processes, such as office applications or the like, on host machines 102, 104, and 106. The stored data may be represented as a set of storage items, such as files organized in a hierarchical structure of folders (also known as directories), which can contain files and other folders, and shares, which can also contain files and folders. Generally, the file server virtual machines may present a single namespace of storage items to user VMs.

In particular embodiments, the VFS 160 may include a set of file server virtual machines (FSVMs) 162, 164, and 166 that execute on host machines 102, 104, and 106. The set of file server virtual machines (FSVMs) may operate together to form a cluster. The FSVMs may process storage item access operations requested by user VMs executing on the host machines 102, 104, and 106. The FSVMs 162, 164, and 166 may communicate with storage controllers provided by CVMs 124, 126, 128 and/or hypervisors executing on the host machines 102, 104, 106 to store and retrieve files, folders, SMB shares, or other storage items. The FSVMs 162, 164, and 166 may store and retrieve block-level data on the host machines 102, 104, 106, e.g., on the local storage 136, 138, 140 of the host machines 102, 104, 106. The block-level data may include block-level representations of the storage items. The network protocol used for communication between user VMs, FSVMs, CVMs, and/or hypervisors via the network 154 may be Internet Small Computer Systems Interface (iSCSI), SMB, Network File System (NFS), pNFS (Parallel NFS), or another appropriate protocol.

Generally, FSVMs may be utilized to receive and process requests in accordance with a file system protocol—e.g., NFS, SMB. In this manner, the cluster of FSVMs may provide a file system that may present files, folders, and/or a directory structure to users, where the files, folders, and/or directory structure may be distributed across a storage pool in one or more shares. The cluster of FSVMs may present a single namespace of storage items of a file system stored in the storage pool.

For the purposes of VFS 160, host machine 106 may be designated as a leader node within a cluster of host machines. In this case, FSVM 166 on host machine 106 may be designated to perform such operations. A leader may be responsible for monitoring or handling requests from FSVMs on other host machines throughout the virtualized environment. If FSVM 166 fails, a new leader may be designated for VFS 160.

In some examples, the user VMs may send data to the VFS 160 using write requests, and may receive data from it using read requests. The read and write requests, and their associated parameters, data, and results, may be sent between a user VM and one or more file server VMs (FSVMs) located on the same host machine as the user VM or on different host machines from the user VM. The read and write requests may be sent between host machines 102, 104, 106 via network 154, e.g., using a network communication protocol such as iSCSI, CIFS, SMB, TCP, Internet Protocol (IP), or the like. When a read or write request is sent between two VMs located on the same one of the host machines 102, 104, 106 (e.g., between the user VM 112 and the FSVM 162 located on the host machine 102), the request may be sent using local communication within the host machine 102 instead of via the network 154. Such local communication may be faster than communication via the network 154 in some examples. The local communication may be performed by, e.g., writing to and reading from shared memory accessible by the user VM 112 and the FSVM 162, sending and receiving data via a local “loopback” network interface, local stream communication, or the like.

In some examples, the storage items stored by the VFS 160, such as files and folders, may be distributed among storage managed by multiple FSVMs 162, 164, 166. In some examples, when storage access requests are received from the user VMs, the VFS 160 identifies FSVMs 162, 164, 166 at which requested storage items, e.g., folders, files, or portions thereof, are stored or managed, and directs the user VMs to the locations of the storage items. The FSVMs 162, 164, 166 may maintain a storage map, such as a sharding map, that maps names or identifiers of storage items to their corresponding locations. The storage map may be a distributed data structure of which copies are maintained at each FSVM 162, 164, 166 and accessed using distributed locks or other storage item access operations. In some examples, the storage map may be maintained by an FSVM at a leader node such as the FSVM 166, and the other FSVMs 162 and 164 may send requests to query and update the storage map to the leader FSVM 166. Other implementations of the storage map are possible using appropriate techniques to provide asynchronous data access to a shared resource by multiple readers and writers. The storage map may map names or identifiers of storage items in the form of text strings or numeric identifiers, such as file system paths, folder names, file names, and/or identifiers of portions of folders or files (e.g., numeric start offset positions and counts in bytes or other units) to locations of the files, folders, or portions thereof. Locations may be represented as names of FSVMs, e.g., “FSVM-1,” as network addresses of host machines on which FSVMs are located (e.g., “ip-addr1” or 128.1.1.10), or as other types of location identifiers.

When a user application, e.g., executing in a user VM 112 on host machine 102, initiates a storage access operation, such as reading or writing data, the user VM 112 may send the storage access operation in a request to one of the FSVMs 162, 164, 166 on one of the host machines 102, 104, 106. An FSVM 164 executing on a host machine 102 that receives a storage access request may use the storage map to determine whether the requested file or folder is located on and/or managed by the FSVM 164. If the requested file or folder is located on and/or managed by the FSVM 164, the FSVM 164 executes the requested storage access operation. Otherwise, the FSVM 164 responds to the request with an indication that the data is not on the FSVM 164, and may redirect the requesting user VM 112 to the FSVM on which the storage map indicates the file or folder is located. The client may cache the address of the FSVM on which the file or folder is located, so that it may send subsequent requests for the file or folder directly to that FSVM.

As an example and not by way of limitation, the location of a file or a folder may be pinned to a particular FSVM 162 by sending a file service operation that creates the file or folder to a CVM, container, and/or hypervisor associated with (e.g., located on the same host machine as) the FSVM 162—the CVM 124 in the example of FIG. 1A. The CVM, container, and/or hypervisor may subsequently process file service commands for that file for the FSVM 162 and send corresponding storage access operations to storage devices associated with the file. In some examples, the FSVM may perform these functions itself. The CVM 124 may associate local storage 136 with the file if there is sufficient free space on local storage 136. Alternatively, the CVM 124 may associate a storage device located on another host machine 104, e.g., in local storage 138, with the file under certain conditions, e.g., if there is insufficient free space on the local storage 136, or if storage access operations between the CVM 124 and the file are expected to be infrequent. Files and folders, or portions thereof, may also be stored on other storage devices, such as the network-attached storage 110 or the cloud storage 108 of the storage pool 156.

In particular embodiments, a name service 168, such as that specified by the Domain Name System (DNS) Internet protocol, may communicate with the host machines 102, 104, 106 via the network 154 and may store a database of domain names (e.g., host names) to IP address mappings. The domain names may correspond to FSVMs, e.g., fsvm1.domain.com or ip-addr1.domain.com for an FSVM named FSVM-1. The name service 168 may be queried by the user VMs to determine the IP address of a particular host machine (e.g., computing node) 102, 104, 106 given a name of the host machine, e.g., to determine the IP address of the host name ip-addr1 for the host machine 102. The name service 168 may be located on a separate server computer system or on one or more of the host machines 102, 104, 106. The names and IP addresses of the host machines of the VFS 160, e.g., the host machines 102, 104, 106, may be stored in the name service 168 so that the user VMs may determine the IP address of each of the host machines 102, 104, 106, or FSVMs 162, 164, 166. The name of each VFS instance, e.g., FS1, FS2, or the like, may be stored in the name service 168 in association with a set of one or more names that contains the name(s) of the host machines 102, 104, 106 or FSVMs 162, 164, 166 of the VFS 160 instance. The FSVMs 162, 164, 166 may be associated with the host names ip-addr1, ip-addr2, and ip-addr3, respectively. For example, the file server instance name FS1.domain.com may be associated with the host names ip-addr1, ip-addr2, and ip-addr3 in the name service 168, so that a query of the name service 168 for the server instance name “FS1” or “FS1.domain.com” returns the names ip-addr1, ip-addr2, and ip-addr3. As another example, the file server instance name FS1.domain.com may be associated with the host names fsvm-1, fsvm-2, and fsvm-3. Further, the name service 168 may return the names in a different order for each name lookup request, e.g., using round-robin ordering, so that the sequence of names (or addresses) returned by the name service for a file server instance name is a different permutation for each query until all the permutations have been returned in response to requests, at which point the permutation cycle starts again, e.g., with the first permutation. In this way, storage access requests from user VMs may be balanced across the host machines, since the user VMs submit requests to the name service 168 for the address of the VFS instance for storage items for which the user VMs do not have a record or cache entry, as described below.

In particular embodiments, each FSVM may have two IP (Internet Protocol) addresses: an external IP address and an internal IP address. The external IP addresses may be used by SMB/CIFS clients, such as user VMs, to connect to the FSVMs. The external IP addresses may be stored in the name service 168. The IP addresses ip-addr1, ip-addr2, and ip-addr3 described above are examples of external IP addresses. The internal IP addresses may be used for iSCSI communication to CVMs, e.g., between the FSVMs 162, 164, 166 and the CVMs 124, 126, 128. Other internal communications may be sent via the internal IP addresses as well, e.g., file server configuration information may be sent from the CVMs to the FSVMs using the internal IP addresses, and the CVMs may get file server statistics from the FSVMs via internal communication.

Since the VFS 160 is provided by a distributed cluster of FSVMs 162, 164, 166, the user VMs that access particular requested storage items, such as files or folders, do not necessarily know the locations of the requested storage items when the request is received. A distributed file system protocol, e.g., MICROSOFT DFS or the like, may therefore be used, in which a user VM 112 may request the addresses of FSVMs 162, 164, 166 from a name service 168 (e.g., DNS). The name service 168 may send one or more network addresses of FSVMs 162, 164, 166 to the user VM 112. The addresses may be sent in an order that changes for each subsequent request in some examples. These network addresses are not necessarily the addresses of the FSVM 164 on which the storage item requested by the user VM 112 is located, since the name service 168 does not necessarily have information about the mapping between storage items and FSVMs 162, 164, 166. Next, the user VM 112 may send an access request to one of the network addresses provided by the name service, e.g., the address of FSVM 164. The FSVM 164 may receive the access request and determine whether the storage item identified by the request is located on the FSVM 164. If so, the FSVM 164 may process the request and send the results to the requesting user VM 112. However, if the identified storage item is located on a different FSVM 166, then the FSVM 164 may redirect the user VM 112 to the FSVM 166 on which the requested storage item is located by sending a “redirect” response referencing FSVM 166 to the user VM 112. The user VM 112 may then send the access request to FSVM 166, which may perform the requested operation for the identified storage item.

A particular VFS 160, including the items it stores, e.g., files and folders, may be referred to herein as a VFS “instance” and may have an associated name, e.g., FS1, as described above. Although a VFS instance may have multiple FSVMs distributed across different host machines, with different files being stored on FSVMs, the VFS instance may present a single name space to its clients such as the user VMs. The single name space may include, for example, a set of named “shares” and each share may have an associated folder hierarchy in which files are stored. Storage items such as files and folders may have associated names and metadata such as permissions, access control information such as ACLs, size quota limits, file types, files sizes, and so on. As another example, the name space may be a single folder hierarchy, e.g., a single root directory that contains files and other folders. User VMs may access the data stored on a distributed VFS instance via storage access operations, such as operations to list folders and files in a specified folder, create a new file or folder, open an existing file for reading or writing, and read data from or write data to a file, as well as storage item manipulation operations to rename, delete, copy, or get details, such as metadata, of files or folders. Note that folders may also be referred to herein as “directories. ” In particular embodiments, storage items such as files and folders in a file server namespace may be accessed by clients, such as user VMs, by name and/or path, e.g., “\Folder-1\File-1” and “\Folder-2\File-2” for two different files named File-1 and File-2 in the folders Folder-1 and Folder-2, respectively (where Folder-1 and Folder-2 are sub-folders of the root folder). Names that identify files in the namespace using folder names and file names may be referred to as “path names.” Client systems may access the storage items stored on the VFS instance by specifying the file names or path names, e.g., the path name “\Folder-1\File-1,” in storage access operations. If the storage items are stored on a share (e.g., a shared drive), then the share name may be used to access the storage items, e.g., via the path name “\\Share-1\Folder-1\File-1” to access File-1 in folder Folder-1 on a share named Share-1.

In particular embodiments, although the VFS may store different folders, files, or portions thereof at different locations, e.g., on different FSVMs, the use of different FSVMs or other elements of storage pool 156 to store the folders and files may be hidden from the accessing clients. The share name is not necessarily a name of a location such as an FSVM or host machine. For example, the name Share-1 does not identify a particular FSVM on which storage items of the share are located. The share Share-1 may have portions of storage items stored on three host machines, but a user may simply access Share-1, e.g., by mapping Share-1 to a client computer, to gain access to the storage items on Share-1 as if they were located on the client computer. Names of storage items, such as file names and folder names, may similarly be location-independent. Thus, although storage items, such as files and their containing folders and shares, may be stored at different locations, such as different host machines, the files may be accessed in a location-transparent manner by clients (such as the user VMs). Thus, users at client systems need not specify or know the locations of each storage item being accessed. The VFS may automatically map the file names, folder names, or full path names to the locations at which the storage items are stored. As an example and not by way of limitation, a storage item's location may be specified by the name, address, or identity of the FSVM that provides access to the storage item on the host machine on which the storage item is located. A storage item such as a file may be divided into multiple parts that may be located on different FSVMs, in which case access requests for a particular portion of the file may be automatically mapped to the location of the portion of the file based on the portion of the file being accessed (e.g., the offset from the beginning of the file and the number of bytes being accessed).

In particular embodiments, VFS 160 determines the location, e.g., FSVM, at which to store a storage item when the storage item is created. For example, an FSVM 162 may attempt to create a file or folder using a CVM 124 on the same host machine 102 as the user VM 114 that requested creation of the file, so that the CVM 124 that controls access operations to the file folder is co-located with the user VM 114. While operations with a CVM are described herein, the operations could also or instead occur using a hypervisor and/or container in some examples. In this way, since the user VM 114 is known to be associated with the file or folder and is thus likely to access the file again, e.g., in the near future or on behalf of the same user, access operations may use local communication or short-distance communication to improve performance, e.g., by reducing access times or increasing access throughput. If there is a local CVM on the same host machine as the FSVM, the FSVM may identify it and use it by default. If there is no local CVM on the same host machine as the FSVM, a delay may be incurred for communication between the FSVM and a CVM on a different host machine. Further, the VFS 160 may also attempt to store the file on a storage device that is local to the CVM being used to create the file, such as local storage, so that storage access operations between the CVM and local storage may use local or short-distance communication.

In some examples, if a CVM is unable to store the storage item in local storage of a host machine on which an FSVM resides, e.g., because local storage does not have sufficient available free space, then the file may be stored in local storage of a different host machine. In this case, the stored file is not physically local to the host machine, but storage access operations for the file are performed by the locally-associated CVM and FSVM, and the CVM may communicate with local storage on the remote host machine using a network file sharing protocol, e.g., iSCSI, SAMBA, or the like.

In some examples, if a virtual machine, such as a user VM 112, CVM 124, or FSVM 162, moves from a host machine 102 to a destination host machine 104, e.g., because of resource availability changes, and data items such as files or folders associated with the VM are not locally accessible on the destination host machine 104, then data migration may be performed for the data items associated with the moved VM to migrate them to the new host machine 104, so that they are local to the moved VM on the new host machine 104. FSVMs may detect removal and addition of CVMs (as may occur, for example, when a CVM fails or is shut down) via the iSCSI protocol or other technique, such as heartbeat messages. As another example, an FSVM may determine that a particular file's location is to be changed, e.g., because a disk on which the file is stored is becoming full, because changing the file's location is likely to reduce network communication delays and therefore improve performance, or for other reasons. Upon determining that a file is to be moved, VFS 160 may change the location of the file by, for example, copying the file from its existing location(s), such as local storage 136 of a host machine 102, to its new location(s), such as local storage 138 of host machine 104 (and to or from other host machines, such as local storage 140 of host machine 106 if appropriate), and deleting the file from its existing location(s). Write operations on the file may be blocked or queued while the file is being copied, so that the copy is consistent. The VFS 160 may also redirect storage access requests for the file from an FSVM at the file's existing location to an FSVM at the file's new location.

In particular embodiments, VFS 160 includes at least three file server virtual machines (FSVMs) 162, 164, 166 located on three respective host machines 102, 104, 106. To provide high-availability, in some examples, there may be a maximum of one FSVM for a particular VFS instance VFS 160 per host machine in a cluster. If two FSVMs are detected on a single host machine, then one of the FSVMs may be moved to another host machine automatically in some examples, or the user (e.g., system administrator) may be notified to move the FSVM to another host machine. The user may move an FSVM to another host machine using an administrative interface that provides commands for starting, stopping, and moving FSVMs between host machines.

In some examples, two FSVMs of different VFS instances may reside on the same host machine. If the host machine fails, the FSVMs on the host machine become unavailable, at least until the host machine recovers. Thus, if there is at most one FSVM for each VFS instance on each host machine, then at most one of the FSVMs may be lost per VFS per failed host machine. As an example, if more than one FSVM for a particular VFS instance were to reside on a host machine, and the VFS instance includes three host machines and three FSVMs, then loss of one host machine would result in loss of two-thirds of the FSVMs for the VFS instance, which may be more disruptive and more difficult to recover from than loss of one-third of the FSVMs for the VFS instance.

In some examples, users, such as system administrators or other users of the system and/or user VMs, may expand the cluster of FSVMs by adding additional FSVMs. Each FSVM may be associated with at least one network address, such as an IP (Internet Protocol) address of the host machine on which the FSVM resides. There may be multiple clusters, and all FSVMs of a particular VFS instance are ordinarily in the same cluster. The VFS instance may be a member of a MICROSOFT ACTIVE DIRECTORY domain, which may provide authentication and other services such as a name service.

In some examples, files hosted by a virtualized file server, such as the VFS 160, may be provided in shares—e.g., SMB shares and/or NFS exports. SMB shares may be distributed shares (e.g., home shares) and/or standard shares (e.g., general shares). NFS exports may be distributed exports (e.g., sharded exports) and/or standard exports (e.g., non-sharded exports). A standard share may in some examples be an SMB share and/or an NFS export hosted by a single FSVM (e.g., FSVM 162, FSVM 164, and/or FSVM 166 of FIG. 1A). The standard share may be stored, e.g., in the storage pool in one or more volume groups and/or vDisks and may be hosted (e.g., accessed and/or managed) by the single FSVM. The standard share may correspond to a particular folder (e.g., \\enterprise\finance may be hosted on one FSVM, \\enterprise\hr on another FSVM). In some examples, distributed shares may be used which may distribute hosting of a top-level directory (e.g., a folder) across multiple FSVMs. So, for example, \\enterprise\users\ann and \\enterprise\users\bob may be hosted at a first FSVM, while \\enterprise\users\chris and \\enterprise\users\dan are hosted at a second FSVM. In this manner a top-level directory (e.g., \\enterprise\users) may be hosted across multiple FSVMs. This may also be referred to as a sharded or distributed share (e.g., a sharded SMB share). As discussed, a distributed file system protocol, e.g., MICROSOFT DFS or the like, may be used, in which a user VM may request the addresses of FSVMs 162, 164, 166 from a name service (e.g., DNS).

Accordingly, systems described herein may include one or more virtual file servers, where each virtual file server may include a cluster of file server VMs and/or containers operating together to provide a file system. Examples of systems described herein may include a file analytics system that may collect, monitor, store, analyze, and report on various analytics associated with the virtual file server(s). By providing a file analytics system, system administrators may advantageously find it easier to manage their files stored in a file system, and may more easily gain, understand, protect and utilize insights about the stored data and/or the usage of the file system over time. Examples of file analytics systems are described as being provided in a hosted system (e.g., cloud computing system), however, it is to be understood that the analytics VM may be implemented in various examples using one or more virtual machines and/or one or more containers or other virtual computing instances.

Accordingly, an analytics system may be in communication with the system 100 of FIG. 1A. The analytics system may retrieve, organize, aggregate, and/or analyze information corresponding to a file system. The information may be stored in an analytics datastore. The analytics system may query or monitor the analytics datastore to provide information to an administrator in the form of display interfaces, reports, and alerts/notifications. The analytics system may be provided as a hosted analytics system on a computing system and/or platform in communication with the VFS 160. For example, the analytics system may be provided as a hosted analytics system in the cloud—e.g., provided on one or more cloud computing platforms.

During operation, the analytics system may perform multiple functions related to information collection, including a metadata collection process to receive metadata associated with the file system, a configuration information collection process to receive configuration and user information from the VFS 160, and an event data collection process to receive event data from the VFS 160.

The metadata collection process may include gathering the overall size, structure, and storage locations of the VFS 160 and/or parts of the file system managed by the VFS 160, as well as details for one or more (e.g., each) data item (e.g., file, folder, directory, share, etc.) in the VFS 160 and/or other metadata associated with the VFS 160. In some examples, the analytics system may communicate with each of the FSVMs 162, 164, 166 of the VFS 160 during the metadata collection process to retrieve respective portions of the metadata.

In some examples, the analytics system may make an initial scan of the VFS 160 to obtain initial metadata concerning the file system (e.g., number of files, directories, file names, file sizes, file owner ID and/or name, file permissions such as ACLs, etc. The analytics system may provide an API call (e.g., SMB ACL call) to the VFS 160 to retrieve owner usernames and/or ACL permission information based on the owner identifier and the ACL identifier. In some examples, either upon a request from the analytics system to the VFS 160, or enablement of the VFS 160 by a user interface of the analytics system, the VFS 160 may start and continue scanning the VFS 160 and auditing events with the ACL identifiers and binary large object(s) (“blob”). Then, audit events may start including ACL identifiers and blob immediately after the VFS 160 is upgraded or deployed to a version that supports permissions. The audit event types which may contain the ACL identifier and blob may include, for example, “DirectoryCreate,” “FileCreate,” “Rename,” “SecurityChange,” and “SetAttr.”

In some examples, the analytics system may communicate with each of the FSVMs 162, 164, 166 of the VFS 160 during the metadata collection process to retrieve respective portions of the metadata from the file system. In some examples, the metadata collection processes performed by the analytics system may include a multi-threaded breadth-first search (BFS) that involves performing parallel threaded file system scanning. The parallel threaded file system scanning may include parallel scanning of different shares, parallel scanning of different folders of a common share, or any combination thereof. In some examples, the metadata collection process may implement a parallel BFS with level order traversal of a directory tree to collect metadata. Level order traversal may include processing a directory tree one level at a time. For example, starting with a top-level directory, a first level of a directory tree is processed before moving onto a next level of the directory tree. The level order traversal includes a current queue, which includes each item in the level of the directory tree currently being processed, and a next queue, which includes children of the level of the directory tree currently being processed. When processing of the current queue is completed, the current queue may be loaded with the next queue entries. By performing level order traversal, a size of the two queues may be more manageable, as compared with a system where every item from a directory tree is loaded into a single queue. The parallel BFS may include starting a thread on each level, and letting processing of all the data items on that level be completed in the current queue before making a move to the next or child queue.

To capture configuration information, the analytics system may use an application programming interface (API) architecture to request the configuration information from the VFS 160. The API architecture may include representation state transfer (REST) API architecture. The configuration information may include user information, a number of shares, deleted shares, created shares, etc. In some examples, the analytics system may communicate directly with the leader FSVM of the FSVMs 162, 164, 166 of the VFS 160 to collect the configuration information. In some examples, the analytics system may communicate directly with another component (e.g., application, process, and/or service) of the VFS 160 or of the distributed computing system 100 (e.g., one or more storage controllers, virtualization managers, the CVMs 124, 126, 128, the hypervisors 130, 132, 134, etc.) to collect the configuration information. In some examples, the analytics system may communicate directly with another component (e.g., application, process, and/or service) of the VFS 160 or of the distributed computing system or in communication with the distributed computing system 100 (e.g., computing node, an administrative system, a storage controller, the CVMs 124, 126, 128, the hypervisors 130, 132, 134, etc.) to collect the configuration information.

To capture event data, the analytics system may interface with the VFS 160 to receive event data for storage in an analytics datastore. The VFS 160 may include or may be associated with an audit framework with a connector that is configured to provide the event data for consumption by the analytics system. For example, the FSVMs 162, 164, 166 of the VFS 160 may each include or may be associated with a respective audit framework 163, 165, 167 with a connector that may provide the event data to the analytics system. In some examples, while the audit framework 163, 165, 167 for each FSVM 162, 164, 166 is depicted as being part of the FSVMs 162, 164, 166, the audit framework 163, 165, 167 may be hosted by another component (e.g., application, process, and/or service) of the VFS 160 or of the distributed computing system 100 (e.g., one or more storage controller(s), the CVMs 124, 126, 128, the hypervisors 130, 132, 134, etc.) without departing from the scope of the disclosure. The audit framework generally refers to one or more software components which may be provided to collect, store, analyze, and/or transmit audit data (e.g., data regarding events in the file system). The event data may include data related to various operations performed with the VFS 160, such as adding, deleting, moving, modifying, etc., a file, folder, directory, share, etc., within the VFS 160. The event information may indicate an event type (e.g., add, move, delete, modify), a user associated with the event, an event time, etc. In some examples, once an event is written to the analytics datastore, it is not able to be modified. In some examples, the analytics system may aggregate multiple events into a single event for storage in the analytics datastore. For example, if a known task (e.g., moving a file) results in generation of a predictable sequence of events, the analytics system may aggregate that sequence into a single event.

In some examples, the analytics system and/or the corresponding VFS 160 may include protections to prevent event data from being lost. In some examples, the VFS 160 may store event data until it is provided to the analytics system. For example, if the analytics system becomes unavailable, the VFS 160 may persistently store the event data until the analytics system becomes available.

To support the persistent storage, as well as provision of the event data to the analytics system, the FSVMs 162, 164, 166 of the VFS 160 may each include or be associated with the audit framework that includes a dedicated event log (e.g., tied to an FSVM-specific volume group) that is capable of being scaled to store all event data and/or metadata for a particular FSVM until successfully sent to the analytics system. In some examples, the audit framework for each FSVM 162, 164, 166 may be hosted by another component (e.g., application, process, and/or service) of the VFS 160 or of the distributed computing system or in communication with the distributed computing system 100 (e.g., a computing node, an administrative system, a storage controller, the CVMs 124, 126, 128, the hypervisors 130, 132, 134, etc.) For example, each respective audit framework 163, 165, 167 may manage a separate respective event log via a separate volume group (e.g., the audit framework 163 manages the volume group 1 (VG1) event log 171, the audit framework 165 manages the volume group 2 (VG2) event log 173, and the audit framework 167 manages the volume group 3 (VG3) event log 175). The VG1-3 event logs 171, 173, and 175 may each be capable of being scaled to store all event data and/or metadata for parts of the VFS 160 that are managed by the respective FSVM 162, 164, 166. In some examples, the data may be persisted (e.g., maintained) until successfully provided to the analytics system. While the VG1-3 event logs 171, 173, 175 are each shown in the respective local storages 136, 138, and 140, the VG1-3 event logs 171, 173, 175 may be maintained anywhere in the storage pool 156 without departing from the scope of the disclosure.

In some examples, if one of the FSVMs 162, 164, or 166 fails, the failed FSVM may be migrated to another one of the host machines (e.g., computing nodes) 102, 104, or 106. In addition, the audit framework 163, 165, or 167 associated with the failed FSVM may also migrate over to the same computing node as the failed FSVM, and may continue updating the same VG1-3 event log 171, 173, or 175 based on the write index. FIG. 1B is a schematic illustration of the distributed computing system 100 of FIG. 1A showing a failover of a failed FSVM in accordance with examples described herein. As shown in FIG. 1B, the FSVM 162 has failed. In response to failure of the FSVM 162, the FSVM 162 may be migrated to the computing node 104 as FSVM 162a. In addition, the audit framework 163 may be migrated to the computing node 104 as the audit framework 163a. The FSVM 162 may mount the VG1 event log 171 to continue updating the event log based on a write index established by the audit framework 163. In some examples, rather than migrating as a separate VM, the file server VM 162's role may be assumed by the file server VM 164 and/or another file server VM. For example, responsive to failure of the FSVM 162, the FSVM 164 or an audit framework associated with the FSVM 164 may manage the VG1 event log 171. The VG1 event log 171 may be migrated to a volume group of the FSVM 164 and/or may otherwise be made accessible to the FSVM 164 and/or an audit framework associated with the FSVM 164.

The audit framework (e.g., each audit framework 163, 165, and/or 167) may include an audit queue, an event logger, an event log, and a service connector. The audit queue may be configured to receive event data and/or metadata from the VFS 160 via network file server or server message block server communications, and to provide the event data and/or metadata to the mediator (e.g., event logger). The event logger may be configured to store the received event data and/or metadata from the audit queue, as well as retrieve requested event data and/or metadata from the event log in response to a request from the service connector. The service connector may be configured to communicate with other services (e.g., such as the analytics VM system) to respond to requests for provision of event data and/or metadata, as well as receive acknowledgments when event data and/or metadata are successfully received by the analytics system. The events in the event log may be uniquely identified by a monotonically increasing sequence number, will be persisted to an event log, and will be read from it when requested by the service connector.

The event logger may coordinate all of the event data and/or metadata writes and reads to and from the event log, which may facilitate the use of the event log for multiple services. The event logger may keep the in-memory state of the write index in the event log, and may persist it periodically to a control record (e.g., a master block). When the audit framework is started or restarted, the master record may be read to set the write index.

Multiple services may be able to read from an event log (e.g., the VG1-3 event logs 171, 173, 175) via their own service connectors (e.g., Kafka connectors). A service connector may have the responsibility of sending event data and metadata to the requesting service (e.g., such as the analytics system) reliably, keeping track of its state, and reacting to its failure and recovery. Each service connector may be tasked with persisting its respective read index, as well as being able to communicate the respective read index to the event logger when initiating an event read. The service connector may increment the in-memory read index only after receiving acknowledgment from its corresponding service and will periodically persist in-memory state. The persisted read index value may be read at start/restart (e.g., or after a service interruption) and used to set the in-memory read index to a value from which to start reading from. In some examples, when an event data record is read from the event log by a particular service, the event logger may stop maintenance of the event data record (e.g., allow it to be overwritten or removed from the event log).

During service start/recovery, a service connector may detect its presence and initiate an event read by communicating the read index to the event logger to read from the event log as part of the read call. The event logger may use the read index to find the next event to read and send to the requesting service (e.g., the analytics system) via the service connector.

The analytics system and/or the VFS 160 may further include architecture to prevent event data from being processed out of chronological order. For example, the service connector and/or the requesting service may keep track of the message sequence number it has seen before failure, and may ignore any messages which have a sequence number less than and equal to the sequence it has seen before failure. An exception may be raised by the message topic broker of the requesting service if the event log does not have the event for the sequence number expected by the service connector or if the message topic broker indicates that it has received a message with a sequence number that is not consecutive. In order to use the same event log for other services, a superset of all the proto fields will be taken to create a common format for an event record. The service connector will be responsible for filtering the required fields to get the ones it needs.

Other mechanisms can be used to implement an audit framework in other examples.

In some examples, the audit framework and event log may be tied to a particular FSVM and its own volume group. Thus, if an FSVM is migrated to another computing node, the event log may move with the FSVM and be maintained in the separate volume group from event logs of other FSVMs.

In some examples, the VFS 160 may be configured with denylist policies to denylist or prevent certain types of events from being analyzed and/or sent to the analytics system, such as specific event types, events corresponding to a particular user, events corresponding to a particular client IP address, events related to certain file types, or any combination thereof. The denylisted events may be provided from the VFS 160 to the analytics system in response to an API call from the analytics system. In addition, the analytics system may include an interface that allows a user to request and/or update the denylist policy, and send the updated denylist policy to the VFS 160. In some examples, the analytics VM 170 may be configured to process multiple channels of event data in parallel, while maintaining integrity and sequencing of the event data such that older event data does not overwrite newer event data.

In some examples, the analytics system may perform the metadata collection process in parallel with receipt of event data. The analytics system may reconcile information captured via the metadata collection process with event data information to prevent older data from overwriting newer data. In cases of reconciliation of the file system state caused by triggering an on demand scan, the state of the files index may be updated by both the event flow process and the scan process. To avoid the race condition, and maintain data integrity, when a metadata record corresponding to a storage item is received, the analytics system may determine if any records for the storage item exist, and if so, may decline to update those records. If no records exist, then the analytics system may add a record for the storage item.

The analytics system may process the metadata, event data, and configuration information to populate the analytics datastore. The analytics datastore may include an entry for each item in the VFS 160. In some examples, the event data and the metadata may include a unique user identifier that ties back to a user, but may not be used outside of the event data generation in some examples. In some examples, the analytics system may retrieve a user ID-to-username relationship from an active directory of the VFS 160 by connecting to a lightweight directory access protocol (LDAP) (e.g., for SMB, perform LDAP search on configured active directory, or on NFS, perform PDAP search on configured active directory or execute an API call if RFC2307 is not configured). In addition, rather than requesting a username or other identifier associated with the unique user identifier for every event, the analytics system may maintain a username-to-unique user identifier conversion table (e.g., stored in cache) for at least some of the unique user identifiers, and the username-to-unique-user identifier conversion table may be used to retrieve a username, which may reduce traffic and improve performance of the VFS 160. In some examples, the user identifiers may be associated with the ACLs. Any mechanism to provide user context for active directory enabled SMB shares may help an administrator understand which user performed which operation as well as ownership of the file.

The analytics system may generate reports, including standard or default reports and/or customizable reports. The reports may be related to aggregate and/or specific user activity; aggregate file system activity; specific file, directory, share, etc., activity; or any combination of thereof. If multiple report requests are submitted at a same time and/or during at least partially overlapping times, examples of the analytics VM may queue report requests and process the requests sequentially and/or partially sequentially. The status of report requests in the queue may be displayed (e.g., queued, processing, completed, etc.). In some examples, the analytics system may manage and facilitate administrator-set archival policies, such as time-based archival (e.g., archive data based on a last-accessed date being greater than a threshold), storage capacity-based archival (e.g., archiving certain data when available storage falls below a threshold), or any combination thereof.

Although some examples for generating and providing metadata and event data are described herein, other mechanisms for obtaining and/or communicating metadata and/or event data from a file server may be used in other examples.

In some examples, the analytics system may be configured to analyze the received event data to detect irregular, anomalous, and/or malicious activity within the file system. For example, the analytics system may detect malicious software activity (e.g., ransomware) or anomalous user activity (e.g., deleting a large amount of files, deleting a large share, etc.).

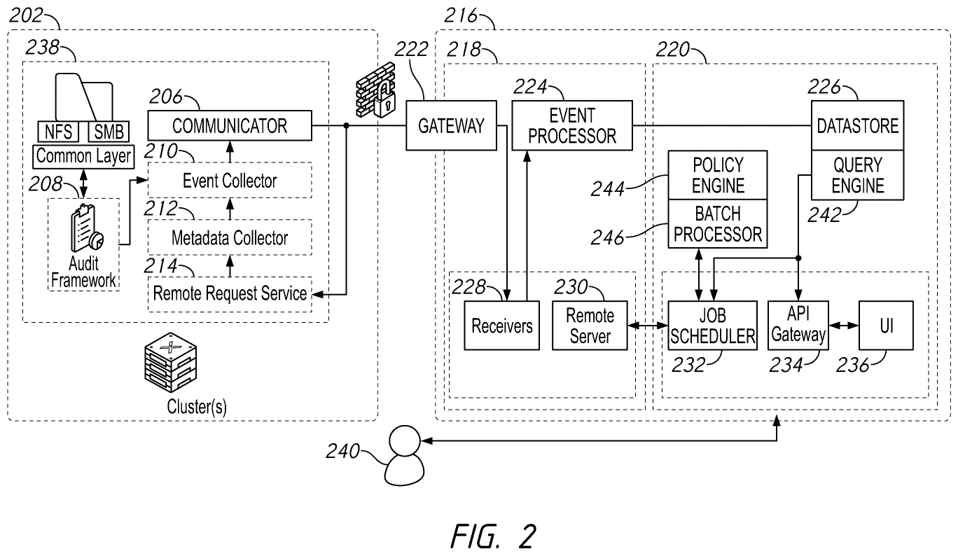

FIG. 2 is a schematic illustration of an analytics system in communication with a file server arranged in accordance with examples described herein. The system includes a file server 202 in communication with analytics system 216. The file server 202 includes FSVM 238. The FSVM 238 may include protocol layer 204, communicator 206, audit framework 208, event collector 210, metadata collector 212, and remote request service 214. The file server 202 may be hosted on a cluster of computing nodes. The analytics system 216 may be a hosted system on one or more cloud service providers. The analytics system 216 may include gateway 222, virtual network 218, and virtual network 220. The virtual network 218 may include event processor 224, receivers 228, and server 230. The virtual network 220 may include batch processor 246, policy engine 244, datastore 226, query engine 242, job scheduler 232, API gateway 234, and user interface 236.

The components shown in FIG. 2 are exemplary. Additional, fewer, and/or different components may be used in other examples. Examples of the analytics system 216 are described herein as provided on AMAZON WEB SERVICES (AWS), although other cloud providers may be used in other examples. The file server 202 is illustrated as including an FSVM (e.g., FSVM 238), however, other file servers which may not include FSVMs may be used in other examples.

The file server 202 of FIG. 2 may be implemented by file servers described herein, such as the virtualized file server described with reference to FIG. 1A and FIG. 1B. For example, the FSVM 238 may be implemented by, or used to implement, one or more of the FSVMs 160, 162, or 164 of FIG. 1A. However, in other examples, other file servers may be used to provide metadata and event data to the analytics system 216.

File servers may collect metadata and event data and provide the metadata and event data to file analytics systems described herein. The metadata for a file system provided by a file server generally may include overall size, structure, and storage locations of parts of the file system managed by the file server, as well as details for each data item (e.g., file, folder, directory, share, owner information, and/or permission information). The details for each data item may include, for example, an identification of the data item, size, name, file type, owner, and/or permissions information. The metadata may be used by file analytics systems described herein to provide analytics regarding the file system. In the example of FIG. 2, the metadata may be collected by metadata collector 212, which may be a service operating within the FSVM 238. The metadata collector 212 for example, may be software (e.g., executable instructions configured to be executed by one or more processors of a host machine hosting the FSVM 238, for example). In some examples, the file server 202 may include a cluster of FSVMs, and each FSVM may include a metadata collector which may collect the metadata of the share, or portion of share, that is associated with that FSVM. The metadata from each FSVM may be communicated to the analytics system from each FSVM, and/or the metadata from each FSVM may be communicated to a leader FSVM on a leader node and provided to the analytics system. The metadata collector 212 may scan the file system, or a portion of the file system accessible to the FSVM 238, and may collect metadata associated with the files in the file system. Other mechanisms may be used to gather file system metadata in other examples.

Example file servers may include event collector(s), such as event collector 210 of FIG. 2. The event collector 210 may be implemented as software (e.g., executable instructions configured to be executed by one or more processors of a host machine hosting the FSVM 238, for example). File servers may utilize event collector(s) to record events that effect the file system. Examples of events include add, move, delete, modify, and rename. An event record may be made for each event which may include an identification of the item associated with the event (e.g., a file, folder, share), a user associated with the event, and an event time. Other attributes of the event may be included in the event record in other examples. In the example of FIG. 2, the event collector 210 may generate the event record and may include events for a share or portion of share associated with the FSVM 238. In some examples, examples of events may include access control entry creation or modification for an active directory or a share. The event data from each FSVM may be communicated to the analytics system from each FSVM, and/or the metadata from each FSVM may be communicated to a leader FSVM on a leader node and provided to the analytics system.

In some examples, the file server may act to collect and/or transmit metadata and/or event data at the request of the analytics system. For example, the file server 202 may perform a metadata scan responsive to a request from analytics system 216. The remote request service 214 may be provided in the file server 202 to receive a request from the analytics system 216, which may be, for example, an API call, to initiate a metadata scan and/or to provide event data. The metadata collector 212 and/or event collector 210 may act in response to a request from analytics system 216 to perform a metadata scan and/or to provide event data. The analytics system 216 may request a metadata scan and/or may request event data using remote request service 214 in some examples.

File servers described herein may accordingly provide one or more file systems. A file system generally refers to an arrangement of files in folders which may be accessed in accordance with a namespace. For example, a path in the namespace may be used to access a particular file. Generally, file servers described herein may have an ability to receive and respond to requests formulated in accordance with a file server protocol, such as NFS and/or SMB. So, the example file server 202 in FIG. 2 may include protocol layer 204. The protocol layer 204 may include an ability to receive an NFS and/or SMB request for files. In some examples, a common layer may be provided in the protocol layer 204 which may allow for the receipt of both NFS and SMB requests to access the namespace of files provided by the file server.

File servers described herein may include an audit framework, such as audit framework 208 of FIG. 2. The audit framework 208 may be one or more software services provided by the audit framework 208, such as by the FSVM 238 of audit framework 208. The audit framework 208 may include a dedicated event log (e.g., tied to an FSVM-specific volume group). The event log may be capable of being scaled to store all event data records and/or metadata for a particular FSVM or other portion of the file system, and may be stored according to a retention policy. The audit framework may include an audit queue, an event logger, an event log, and a service connector. The audit framework may receive event data records and/or metadata from the file server and to provide the event data records and/or metadata to the event collector 210 and/or metadata collector 212. In some examples, the event data records may be stored with a unique index value, such as a monotonically increasing sequence number, which may be used as a reference by the requesting services to request a specific event data record. The event logger may keep the in-memory state of the write index value in the event log, and may persist it periodically to a control record (e.g., a master block). In some examples, the event may include updating of an ACL for an active directory or a share. When the audit framework is started or restarted, the master record may be read to set the write index.

File servers described herein may include a communication component, such as communicator 206. The communicator 206 may be implemented using a software service operating on a host machine that forms part of the file server 202. The communicator 206 may provide event and/or metadata to the analytics system 216. For example, the communicator 206 may provide data from the event collector 210 and/or metadata collector 212 to the analytics system 216. The communicator 206 may connect to the analytics system 216 over a network, such as the Internet. For example, the analytics system 216 may be a hosted solution residing in a cloud service provider, and the file server 202 may be an on premises file server which may communicate with the cloud service provider using communicator 206.

In this manner, during operation of a file server, metadata and event data regarding files and other items, including ACL identifiers and ACL blobs, in a file system may be collected by the file server. The metadata and/or event data including ACL identifiers and ACL blobs may be provided to an analytics system, such as the analytics system 216 of FIG. 2.

Accordingly, file analytics systems described herein may maintain a data repository, such as a datastore 226 of FIG. 2, which may contain records corresponding to data items in a file system. The records may be populated using metadata from the file system, and may be updated (e.g., maintained) based on event data from the file system. For example, a rename event from the file system may cause the event processor 224 to update a name of a data item in the datastore 226 in accordance with the event. The records in the datastore 226 may include, by way of example, an ID of the item (e.g., an inode number), a name, size, file type, owner, and most recent user. Other information may be included in other examples. In some examples, the datastore 226 may additionally or instead include a record associated with each event received from the file system. For example, the datastore 226 may include a record of an event including an ID of a data item (e.g., a file) involved in the event, a type of event, and updated information regarding the data item following the event (e.g., new name and/or location). The datastore 226 may be implemented using a database in some examples (e.g., an elastic search database). In some examples, the datastore 226 may be implemented using a data warehouse. For example, SNOWFLAKE may be used to implement datastore 226 in some examples.

A data warehouse generally refers to a data management system that may be used to store enterprise data and provide an analytical processing function to access the data. Accordingly, query engine 242 is depicted in FIG. 2 to represent processing functionality that may be used to query, access, write, or otherwise manipulate data to the datastore 226. The query engine 242 may be integral to the datastore 226 in some examples. The query engine 242 may be implemented using software, such as in a virtual machine or container or other virtualized computing system provided by a cloud provider. The query engine 242 may be implemented using computer readable media encoded with executable instructions which, when executed, cause one or more processors to perform the query engine functionality described herein. Generally, the query engine 242 may provide an analytical processing function of a data warehouse, including an ability to iteratively query the data in the data warehouse. A data warehouse may include a relational database and extraction, loading, and/or transformation software processes to prepare data in the data warehouse for analysis. The data warehouse may provide other functions for querying and/or analyzing data in some examples. Generally, a data warehouse may not include traditional indexes that may historically be used in relational databases to speed up access to the data. Rather, a system of iterative queries may be used to access the data in a data warehouse. These iterative queries and other functionality may be performed by query engine 242 in some examples.

Examples of analytics systems described herein may include a batch processor that may be utilized to execute batch operations on the file system based on the metadata and event data obtained by the file analytics system. For example, the analytics system 216 of FIG. 2 includes batch processor 246. The batch processor 246 may be implemented using AWS BATCH, for example. The batch processor 246 may be a software service that facilitates batch operations using data from the datastore 226. In some examples, the jobs that may be executed by the batch processor 246 are generated and/or scheduled by a scheduler, such as job scheduler 232 of FIG. 2.

Examples of analytics systems described herein may include a user interface. For example, the analytics system 216 of FIG. 2 may include user interface 236. The user interface 236 may allow a user, such as user 240 of FIG. 2, to access one or more reports or data based on data in the datastore 226. The user interface 236 may include a display and/or one or more input and/or output device(s) including an interface to receive text and/or click or other touch inputs. The user 240 may be a human user and/or may be one or more other software processes or computing systems which may interact with analytics system 216.

Examples of analytics systems described herein may receive ACLs and their blobs regarding files and may monitor permissions for SMB shares and active directories. For example, the analytics system 216 of FIG. 2 may calculate risk against such shares and provide ability to generate reports for metrics related to permissions. The analytics system 216 may assist finding permissions-related risk areas, identify and provide weight on data that may be useful in permission management decisions, or risk assessment. The analytics system 216 may monitor risk profile and permission details of share or directory of a file server, such as the VFS 160 of FIG. 1A and/or FIG. 1B, based on metadata and/or events data collected by file analytics systems. The analytics system 216 may inform permission details for any user or user group over any directory or share to aid in remediation through a user interface, such as the user interface 236.

Virtualized file servers, such as VFS 160 of FIG. 1A and/or FIG. 1B may provide ACL identifiers and ACL blobs to an analytics system, such as the analytics system 216 of FIG. 2. For example, the analytics system 216 may make an initial scan of the VFS 160 to obtain initial metadata concerning the file system (e.g., number of files, directories, file names, file sizes, file owner ID and/or name, file permissions such as ACLs, etc.). The analytics system 216 may provide an API call (e.g., SMB ACL call) to the VFS 160 to retrieve owner usernames and/or ACL permission information based on the owner identifier and the ACL identifier. In some examples, upon either a request from the analytics system 216 to the VFS 160, or enablement of the VFS 160 by the user interface 236 of the analytics system 216, the VFS 160 may start and continue scanning the VFS 160 and auditing events with the ACL identifiers and ACL blobs. Then, audit events may start including ACL identifiers and blobs immediately after the VFS 160 is upgraded or deployed to a version that supports permissions. The audit event types which may contain the ACL identifier and blob may include, for example, “DirectoryCreate,” “FileCreate,” “Rename,” “SecurityChange,” and “SetAttr.” Accordingly, in some examples, during normal operation, the ACL identifiers and ACL blobs for data (e.g., files and folders) of the VFS 160 may be provided to the analytics system 216.

The analytics system 216 may receive the metadata and/or events data at a gateway 222. Analytics systems described herein may include one or more receiver processes, such as receivers 228 of FIG. 2. The receivers 228 may receive the metadata and/or event data provided by the file server through the gateway 222. Metadata and/or event data, including ACL identifiers and ACL blobs, may be provided to an event processor 224 through a cloud. Examples of the cloud are described herein as provided on AMAZON s3, although other cloud service may be used in other examples. The event processor 224 may be implemented using a software process in the hosted cloud environment. For example, the event processor 224 may be implemented using AWS KINESIS and/or AWS LAMBDA. The event processor 224 may process a data stream from the file server and store metadata in a datastore, such as datastore 226. The metadata may be used, for example, to create a record in datastore 226 for each item in the file system. In some examples, the receivers 228′ writing the ACL identifiers and ACL blobs on the cloud may trigger the event processor 224 to evaluate ACL identifiers and ACL blobs. In some examples, the event processor 224 may derive effective and static permissions for the applicable files and folders. The evaluated effective and static permissions may be stored on the datastore 226. In some examples, the evaluated effective and static permissions may be written into corresponding tables in the datastore 226. Accordingly, the records in the datastore 226 may be updated by the event processor 224 in response to event data from the file server. For example, whenever the ACL information is updated, such event may be provided by the file server.

Example analytics systems may provide information to the file server based on captured metadata and/or events data regarding the stored files. The information provided by analytics based on metadata and events may be used by the VFS 160 to implement, create, modify, and/or update permission levels or access permitted user or user group in ACLs and/or ACEs.

Individual files may be stored as objects in a storage (e.g., implemented as part of and/or as an extension of storage pool 156 of FIG. 1A and/or FIG. 1B). When a file is moved to the storage, the data may be truncated from the primary storage in order to save space. The truncated file remains on the primary storage containing the metadata, e.g., ACLs, extended attributes, alternative data stream, and tiering information. For example, pointers (such as URLs) to access the objects in the storage containing the file data may be stored. When the truncated file on the primary storage is accessed by a client (e.g., by a user VM), the data is available from the storage.

In some examples, some analysis to effective permission and/or how and/or when incident or high risk access may be made at least in part by the data model implemented by an analytics system described herein. For example, the datastore 226 of FIG. 2 may be used. The datastore 226 includes a query engine 242 that may determine what files are affected based on file access patterns, and/or attributes (e.g., metadata and/or event data related to ACLs and blobs obtained by the file server 202 and stored in datastore 226). In some examples, permission tables stored in the datastore 226 may keep track of the updates regarding ACLs. Examples of analytics systems, such as the analytics system 216 described herein, may receive ACLs including ACEs from a file server, such as the file server 202, as part of scan and audit events when there are changes to data. In some examples, the changes to the data may include a change in either one or more permissions or one or more memberships of a storage item (e.g., a file or a share) in an active directory.

The data model may store all ACL related information. The data model may process a query issued by the query engine 242. At the analytics system 216, the query engine 242 of the datastore 226 may re-evaluate the effective permission of the ACL upon detecting the change. The effective permission after re-evaluation may be stored in a data repository, such as the datastore 226.

In some examples, the data model may return directories that a given user or a list of users has access to based on the given user or the list of users in the query. In some examples, the data model may return users that have access to a directory or a list of directories based on the given directory or list of directories in the query. In some examples, the data model may return groups that have access to a directory or list of directories based on the given directory or list of directories in the query. Because the effective permissions for active directories may be obtained from the data model implemented as the datastore 226, accessing the effective permission at the data repository may be performed regardless of availability of a file server. For example, the effective permissions for active directories may be obtained during a time the file server 202 is unavailable to the analytics system 216 (e.g., when the file server 202 is down, the file server 202 is disconnected from the analytics system 216, etc.). The file server 202 may, for example, be wholly and/or partially disconnected from network access. The file server 202 may, for example, be unresponsive to queries. The file server 202 may be made unavailable to certain users, groups, entities, and/or other computer systems responsive to certain events, such as suspected or actual ransomware events, malicious activity events, and/or during periodic maintenance or other times. It may be advantageous to be able to determine effective permission information even during times that the file server 202 may be unavailable. Being able to query and access effective permission information during times that the file server 202 is unavailable may allow for more accurate forensic analysis of the event which caused the file server to become unavailable. Being able to query and access effective permission information during times that the file server 202 is unavailable may allow for more reliable access to the information during upgrade and/or maintenance of the file server 202.

The event may be sent through the data pipeline (e.g., by communicator 206 to gateway 222). In this manner, the file analytics system may store indications in the analytics datastore 226 that certain data's ACL has been updated. Reports and other displays may then be accurate as to the ACL status of files in the file server.

In some examples, the analytics system 216 may synchronize (e.g., receive) ACLs. The event processor 224 may check if there is any share scan running. If not, the event processor 224 may check whether the run analysis is triggered due to an on-demand request from the user. If that is the case, the event processor 224 may check whether the last run timestamp is older than the minimum wait threshold. If the last run timestamp is newer, then the event processor 224 returns an error and the user interface 236 may provide the user 240 a message asking to wait until the minimum wait threshold elapses. In some examples, the event processor 224 may further check if the eligible events count is greater than the count threshold, and if not, exit this ACL identifier request and synchronization process. If the last run timestamp is older than the time threshold, ACL identifiers that need to be synchronized may be identified. In some examples, the ACL identifiers that need to be synchronized may be the ACL identifiers with information missing in the datastore 226. The analytics system 216 may send a remote diagnostic request, such as an RCC request, to the remote request service 214 of the file server 202. The request payload for this request will be a list of records (dict/tuple/list) where each record may contain an inode number, genid and ACL identifier. For multiple files having the same ACL identifier, the inode number and genid of any one file may be selected (e.g., there may be one record per ACL identifier in the request). The analytics system 216 may wait for the RCC response. If the RCC response is not received for a wait threshold time (e.g., failed), retry the request. In some examples, a maximum retry count may be predefined and configurable from a database on the datastore 226, and if no response is received after maximum retries, exit this ACL synchronization after providing an error message to the user 240 (through user interface 236 of FIG. 2). The response may be received on a predefined cloud. In some examples, the response may be provided as a compression file, such as a tar file. The analytics system 216 may process the response and store permission information based on the obtained ACL information on tables stored in the datastore 226.

In some examples, the analytics system 216 may synchronize (e.g., receive) active directory membership information, such as group membership information. For example, this synchronization process may be configured to be activated in various manners, including: periodically (e.g., daily, every predetermined hour), or when a command from a user interface triggers (on-demand). In some examples, the on-demand trigger may cause the synchronization process, if such synchronization process is not already running, or the last successful run was more than a predetermined wait time (e.g., three hours). In some examples, the analytics system 216 may execute a supervisor process which may wake up periodically (e.g., every hour) to check whether this synchronization process is configured to be executed based on the above triggers. In case of on-demand trigger, the synchronization process may run immediately. The event processor 224 or the job scheduler 232 of the analytics system 216 may check whether the last run timestamp is older than the minimum wait threshold (e.g., three hours). If the last run timestamp is newer, then the event processor 224 returns an error and the user interface 236 may provide the user 240 a message asking to wait until the minimum wait threshold elapses. If the synchronization process is due to a periodic process which runs at a default frequency (e.g., every 24 hours), the process may run without checking the last run timestamp.

In some examples, the analytics system 216 may send a remote diagnostic request, such as an RCC request, to the remote request service 214 of the file server 202. The request payload for this request will be a list of active directory data. The analytics system 216 may wait for the RCC response. If the RCC response is not received for a wait threshold time (e.g., failed), retry the request. In some examples, a maximum retry count may be predefined and configurable from a database on the datastore 226, and if no response is received after maximum retries, exit this active directory synchronization after providing an error message to the user 240 (through user interface 236 of FIG. 2). If successful, the response may be received on a predefined cloud. In some examples, the response may be provided as a compression file, such as a tar file. The analytics system 216 synchronizes the group membership information for all active directories for/of each synchronization. This active directory user to group information synchronization may not be an incremental synchronization or based on any data conditions of the analytics system 216.

User interfaces (e.g., the user interface 236 of FIG. 2) may provide an interface for a user to view, set, modify, and/or update effective permission levels or access permitted user or user group in ACLs and/or ACEs. The user interface 236 may be used by a user 240 to receive information about effective permission for target shares or active directories and credentials to be used by the virtualized file server (e.g., VFS 160) to analyze incidents and risks potentially caused from or implied by the effective permission levels. The captured profile details may be communicated to the virtualized file server via remote command. The user may also set the permission policy via the user interface 236 and this may be stored on an analytics datastore (e.g., datastore 226). Permission criteria may be defined. For example, one or more exclusion criteria or prioritization criteria may be defined. In some examples, the criteria may include, for example, for file size, particular shares, and/or file types, such as categories or extensions, user, user group.

The policy engine (e.g., policy engine 244) may be implemented using a cron job that may run periodically and may update effective permission infuriation. For example, the cron job may be implemented by a job scheduler 232 that may be used to implement policy engine 244. The files which meet the criteria may be communicated to the VFS via a remote command (e.g., to remote request service 214) for modification of ACL information.

Example data analytics systems, such as the data analytics system 216, may perform feature activation. In some examples, the analytics system 216 may check if permission management may be auto-activated or deactivated for the file server 202. In some examples, an auto-activation may be performed based on whether the analytics system 216 is configured to process permissions (e.g., permission aware) and the file server 202 is configured to be permission aware or configured to be updated from a non-permission aware version to a permission-aware version. Furthermore, the auto-activation may be performed based on whether the file server 202 may be performing under a license that supports the ACL check feature. In some examples, the license may be a paid license. During the auto-activation, the data analytics system 216 may create tables, procedures, tasks, and streams in the datastore 226. The analytics system 216 may further update a configuration or add seed data in the datastore 226. The analytics system 216 may use the auto-activation process for activating other features. In some examples, the auto-activation may be configured to be performed in various manners, including: periodically (e.g., daily, every predetermined hour), or when a command from a user interface triggers (on-demand). In some examples, the on-demand trigger may cause the synchronization process, if such synchronization process is not already running, or last successful run was more than a predetermined wait time (e.g., three hours). In some examples, the analytics system 216 may execute a supervisor process which may wake up periodically (e.g., every hour) to check whether this auto-activation process is configured to be executed based on the above triggers. In case of an on-demand trigger, the auto-activation process may run immediately. The event processor 224 or the job scheduler 232 of the analytics system 216 may check whether the last run timestamp is older than the minimum wait threshold (e.g., three hours). If the last run timestamp is newer, then the event processor 224 returns an error and the user interface 236 may provide the user 240 a message asking to wait until the minimum wait threshold elapses. If the auto-activation process is due to a periodic process which runs at a default frequency (e.g., every 24 hours), the process may run without checking the last run timestamp.

The analytics system 216 may create the ACL identifiers and enable synchronizing ACL blobs for the ACL identifiers and synchronizing the active directory user to a group. In some examples, the analytics system 216 may trigger scanning of shares to get ACL identifiers for all files and folders. An auto-deactivation may be performed based on whether the file server 202 may be on a non-permission-aware version, regardless of the analytics system 216's ability to process permission information (e.g., the analytics system 216 is permission aware). During the auto-deactivation, changes may be performed within the datastore 226 to disable or destroy tables, procedures, etc. for permission management that may have been created at that point. Furthermore, ACL blob synchronization based on the ACL identifiers and synchronization of the active directory user to a group may be disabled by the analytics system 216.

The audit events may contain the object identifier (e.g., object ID and/or file ID) and the corresponding ACL identifier. The evaluated audit event may be stored in the datastore (e.g., datastore 226 of FIG. 2). The audit event indicative of access failure may contain a reason for failure, and a file table entry for that file may be updated with the reason.

Based on the collected information and current state of the objects, the analytics system (e.g., analytics system 216, such as by using policy engine 244 and the data model implemented as the datastore 226) may calculate a risk score from effective access information of a particular active directory or a share. This information may aid users to configure permission policies for effective utilization of the file server, balancing between performance and risk in some examples.

Accordingly, the user 240 may utilize file analytics determined based on collected metadata and/or events data from the file server to calculate which files may have a high risk score by evaluating ACLs. The event processor and a batch processor of an analytics system may generally include a collection of services which may work together to provide this functionality. The event processor and the batch processor may execute batch processing in the background, and call file server APIs to update ACLs, or receive updated ACLs from the file server. The datastore 226 may include permissions tables that may keep track of updates on ACLs in the process of assessing effective permission information.

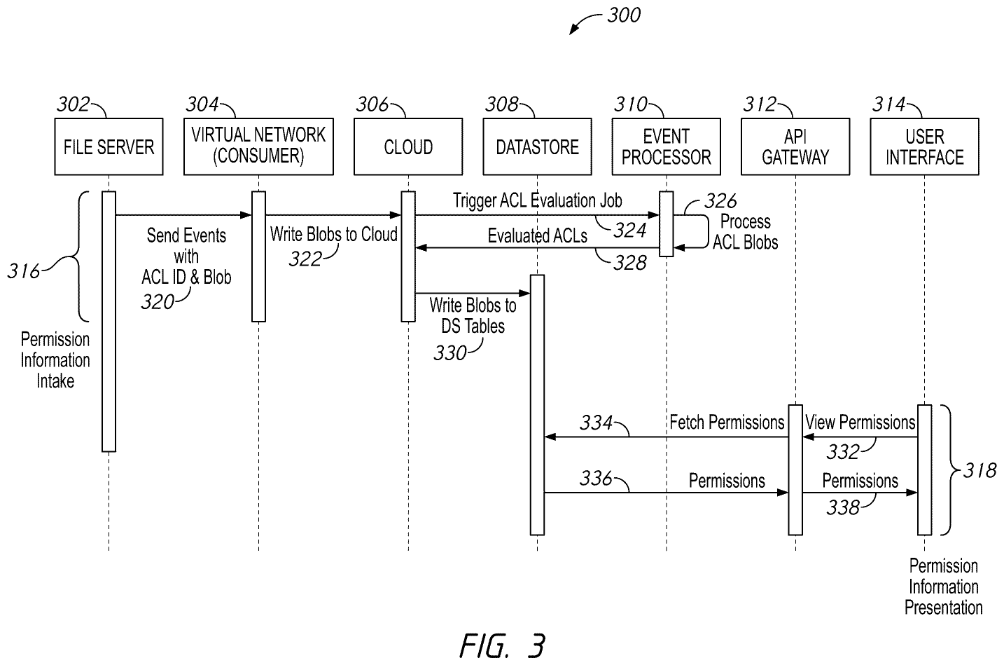

FIG. 3 is a communication flow diagram illustrating a method 300 of monitoring effective access permission in accordance with examples described herein. The method 300 of FIG. 3 may be implemented, for example, using analytics system 216 of FIG. 2. For example, the method 300 may be executed, at least in part, by a file server 302, a virtual network 304, a cloud 306, a datastore 308, an event processor 310, an API gateway 312, and a user interface 314. In some examples, the file server 302 may be the file server 160 of FIGS. 1A and 1B and/or the file server 202 of FIG. 2. In some examples, the virtual network 304 may be the virtual network 218 of FIG. 2. In some examples, the cloud 306 may be the cloud of FIG. 2. In some examples, the datastore 308 may be the datastore 226 of FIG. 2. In some examples, the event processor 310, the API gateway 312, and the user interface 314 may be the event processor 224, the API gateway 234, and the user interface 236 of FIG. 2, respectively.

The method 300 may include several stages. In some examples, the stages may include a permission information intake 316 and permission information presentation 318. While examples of method 300 described herein may be described with reference to receipt of ACL input from the file server 302, in some examples, the information gathered during method 300 may be predetermined and/or stored as an initial configuration. In some examples, some or all of the information gathered during method 300 may be requested and/or received from a file server described herein. For example, in some examples, the permission information intake 316 may be repeated as an ACL in the file server 302 may be updated. In some examples, the permission information intake 316 may be repeated periodically.

The permission information intake 316 may include blocks 320-330. The permission information intake 316 may start with receiving ACL identifiers and ACL blobs. In block 320, the file server 302 performs scan and audit events and provide events with the ACL identifiers and ACL blobs to the virtual network 304. In some examples, the virtual network 304 may be a consumer. In some examples, the scan events may be provided once the file server 302 may be enabled by a user interface of an analytics system, such as the user interface 236 of the analytics system 216. In some examples, the scan events may be provided responsive to a share scan request from the analytics system to the file server 302. Audit events may include ACL identifiers and blobs when the file server is upgraded/deployed to a version that supports permissions. The audit event types which may contain the ACL identifier and blob may include, for example, “DirectoryCreate,” “FileCreate,” “Rename,” “SecurityChange,” and “SetAttr.” Through the method 300, communication with the file server 302 may be performed in the block 320. Through the blocks 322-338, the file server 302 may not be communicated.

In some examples, the ACL blobs may be converted into static and effective permissions. In block 322, the virtual network 304 may store the ACL identifiers and ACL blobs on the cloud 306. In some examples, the event processor 310 of the virtual network 304 may process the event and write event data to the datastore 308. In block 324, the event processor 310 may be triggered by storing of the ACL identifiers and ACL blobs to perform evaluation of ACLs on the cloud 306. In block 326, responsive to the trigger, the event processor 310 may parse the ACL blobs and evaluate the ACL blobs into effective permissions. In some examples, ACL is a list made of ACEs. Each ACE has a format, indicating to an administrator or to a file server, such as the file server 302, that a security principal (e.g., user or group) has a certain level of access; the level of access is defined by permissions indicated in that entry. For example, levels of access may include “full control,” “modify,” “read and execute,” “write,” read,” “list folder content,” etc. Each ACE may also indicate, for example, whether the permissions were inherited (e.g., from a parent). Some of these permissions could have come from the parent; some could be directly set on this directory. Every storage item on a file system (e.g., file and directory) may have an ACL. In some examples an ACL may be managed at a directory level. ACLs may be defined at a higher level of the directory/file hierarchy, and the ACLs may be inherited to directories/files, and changes to the ACLs may also be inherited downwards. In some examples, permissions can be given at a user level or at a group level. The effective permission may reflect a combination of the user level and the group level permissions. In some examples, the effective permissions may be calculated further using active directory user memberships indicating relationships between group(s) and user(s). In block 328, static and effective permissions, as evaluated ACL blobs, may be stored on the cloud 306. In block 330, the static and effective permissions may be written into respective tables stored in the datastore 308. The datastore 308 may determine what files are affected based on file access patterns, and/or attributes (e.g., metadata and/or event data related to ACLs and blobs received from the file server 202 and stored in datastore 226). In some examples, the datastore 308 may include a query engine, such as the query engine 242 of FIG. 2. Because permission tables stored in the datastore 226 may keep track of the updates regarding ACLs, the datastore 308 using the query engine may detect when there are changes to the data. In some examples, the changes to the data may include a change in either one or more permissions or one or more memberships of a storage item (e.g., a file or a share) in an active directory as stored in the datastore 308. In some examples, using the query engine, the datastore 308 may re-evaluate the effective permission of the ACL upon detecting the change. The effective permission after re-evaluation may be stored in permission tables in the datastore 308. Because the effective permissions for active directories may be received from the datastore 308, accessing the effective permission at the data repository may be performed regardless of availability of a file server, such as the file server 302. Accordingly, the static and effective permissions may become available to users of the datastore 308, regardless of a connection status between the datastore 308 and the file server 302.

The permission information presentation 318 may include blocks 332 to 338. In block 332, the user interface 314 may send an API call with relevant details to request viewing information related to effective permissions to the API gateway 312. In block 334, the API gateway 312 may request (e.g., fetch) the effective permissions from the datastore 308. In block 336, the datastore 308 may return the effective permissions responsive to the request from the API gateway 312. In block 338, the API gateway 312 may return the effective permission to the user interface 314, thus the user interface 314 may provide the effective permissions to the user. Accordingly, the user may view effective permissions from the user interface 314.

In some examples, a batch processor and a job scheduler described herein may implement batch processing. Within that batch of files, a subset of the largest files may be selected for updating. In a next run, the batch processor may again select a batch of next oldest and/or least recently accessed files. Within that batch of files, a subset of the largest ACL blobs may be received and processed for updating effective permission information. In this manner, overhead may be reduced for ACL evaluations at the time of viewing by the user while providing more effective use of the permission status of the file server.

Moreover, file servers may constantly be undergoing changes during use (e.g., write, append, truncate) and the age and/or last access time (e.g., time of last read and/or write) of files may be constantly changing. There may be a time gap between when an ACL is updated and when the permission information is used for queries, such as risk calculation. Accordingly, a combination of event processors and policy engines described herein with a batch processor, such as the batch processor 246, may advantageously in some examples process batches of files for ACL evaluations (e.g., files from a first-time window, largest files in that batch, then files from another time window). In this manner, a gap between a time an ACL is evaluated and when queries are performed for viewing permission statuses or risk calculations may be reduced, because effective permission evaluations based on multiple ACL blob changes may be performed over time (e.g., one for each time window) rather than a single decision time.

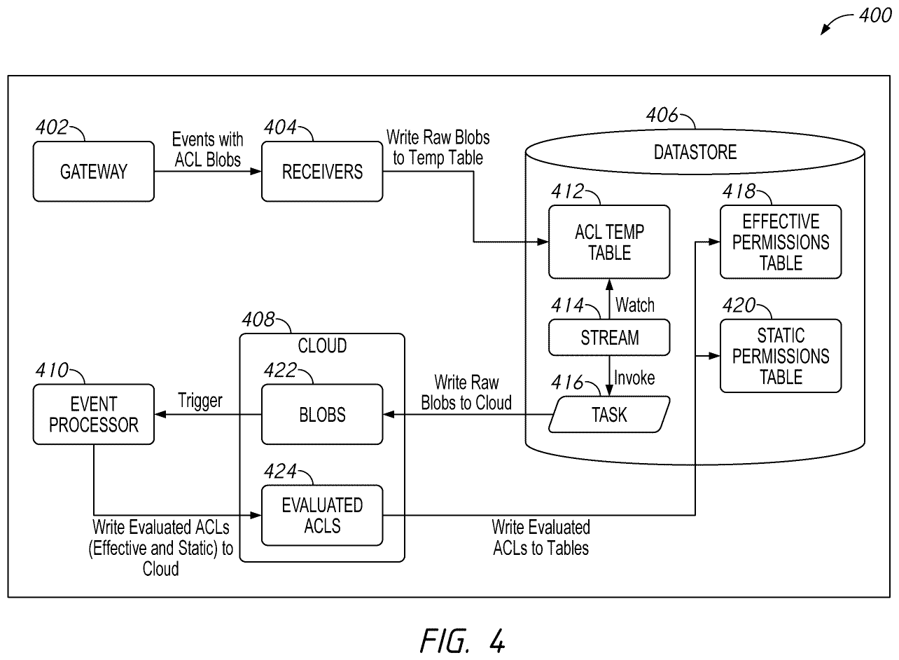

FIG. 4 is a schematic illustration of an analytics system 400 in accordance with examples described herein. The analytics system 400 may evaluate effective permissions from raw ACL blobs. The components shown in FIG. 4 generally may be implemented using software (e.g., executable instructions, which, when executed, cause one or more processors to perform the functions described). The components in FIG. 4 are exemplary only. Additional, fewer and/or different components may be used in other examples. The analytics system 400 of FIG. 4 may be implemented by and/or used to implement and/or may be implemented by analytics systems described herein, such as the analytics system 216 of FIG. 2. Examples of analytics systems described herein, such as the analytics system 400 of FIG. 4, may include a gateway 402, one or more receivers 404, a datastore 406, a cloud 408, and an event processor 410. The datastore 406 may include an ACL temporary table 412, a stream 414, a task 416, an effective permissions table 418, and a static permissions table 420. The cloud 408 may include blobs 422, and evaluated ACLs 424. In some examples, the analytics system 400 may implement the method 300 of FIG. 3. In some examples, the gateway 402, the one or more receivers 404, the datastore 406, the cloud 408, and the event processor 410 may be the gateway 222, the receivers 228, the datastore 226, the cloud, and the event processor 224 of FIG. 2. In some examples, the gateway 402 and the one or more receivers 404 may be included in the virtual network 304 of FIG. 3. In some examples, the cloud 408, the datastore 406, and the event processor 410 may be implemented as the cloud 306, the datastore 308, and the event processor 310 of FIG. 3.

The ACL blobs may be received, for example, during scanning and auditing events for active directories or included in an RCC response provided through a batch job for share permissions. The gateway 402 may receive the events with ACL blobs from a file server and provide the events with ACL blobs to the receivers 404. In some examples, the analytics system 400 may synchronize ACLs. The analytics system 400 may receive an ACL blob from a file server for ACL identifiers that do not have any ACL information against them in the datastore 406. In some examples, such ACL identifiers to be synchronized may be found by searching all records in the ACL temporary table 412 having an empty ACL blob field. This synchronization process may be activated. For example, this synchronization process may be configured to be activated in various manners, including: periodically (e.g., daily, every predetermined hour), when a count of unresolved ACL identifiers exceeds a predetermined threshold, or when a command from a user interface triggers (on-demand). In some examples, the count-based trigger may override the periodic trigger without waiting for the period. In some examples, the on-demand trigger may cause the synchronization process, if such synchronization process is not already running, or last successful run was more than a predetermined wait time (e.g., three hours). In some examples, the datastore 406 may execute a supervisor process which may wake up periodically (e.g., every hour) to check whether this synchronization process is configured to be executed based on the above triggers. In case of on-demand trigger, the synchronization process may run immediately. In some examples, the ACL blobs may be obtained as described herein with regards to execution of obtaining ACL blobs by the event processor 224 of FIG. 2. In some examples, this synchronization process may be created as a system process and performed by a batch processor 246 of FIG. 2 with a job scheduler 232 and may not be visible on the user interface 314. In some examples, this synchronization process may be included in file analysis tasks to be performed in the task 416.

The receivers 404 may write the ACL blobs to an ACL temporary table 412 in the datastore 406 under the file server's schema. In some examples, storing the ACL blobs in the ACL temporary table 412 is advantageous for several reasons. For example, each blob received via the gateway 402 may become trackable together with its processing/evaluation status. Each blob is used temporarily while obtaining effective permission information and not a permanent data to be stored. For example, records of processed blobs from the ACL temporary table 412 may be cleaned up periodically through a task of the datastore 406. The stream 414 of the datastore 406 may watch the ACL temporary table 412 for changes, and upon detecting any changes, the stream 414 may call the predefined task 416. The task 416 may obtain (e.g., fetch) unprocessed records from the ACL temporary table 412 in a configurable batch size. In some examples, the batch size may be up to 100 blobs. The task 416 may write the unprocessed records in the batch size as a single object (“blobs 422”) to the cloud 306. This write operation to the cloud 408 may trigger the event processor 410. The event processor 410 may read the object and extract the blobs 422. The event processor 410 may process the blobs 422 in sequence. The event processor 410 may parse each blob of the blobs 422 from its raw form to a readable ACL object. The event processor 410 may evaluate the parsed ACL write evaluated ACLs 424 to the cloud 408. The event processor 410 may convert the evaluated ACLs 424 into a list of effective permissions. In some examples, the list of effective permissions may be added to the datastore 406 update queue. Based on time remaining to the event processor 410, the event processor 410 may determine whether the event processor 410 may merely complete evaluation and may provide the evaluated list of effective permissions to the datastore 406 or the event processor 410 may continue processing more ACLs. The ACL temporary table 412 may be updated for the ACLs based on the progress. The remaining ACLs may be processed in the next process execution of the event processor 410. The event processor 410 may continue providing parsed and evaluated ACLs 424 as the list of effective permissions to a pre-defined cloud path, and the evaluated ACLs 424 may be written into the effective permissions table 418 and static permissions table 420 of the datastore 406.

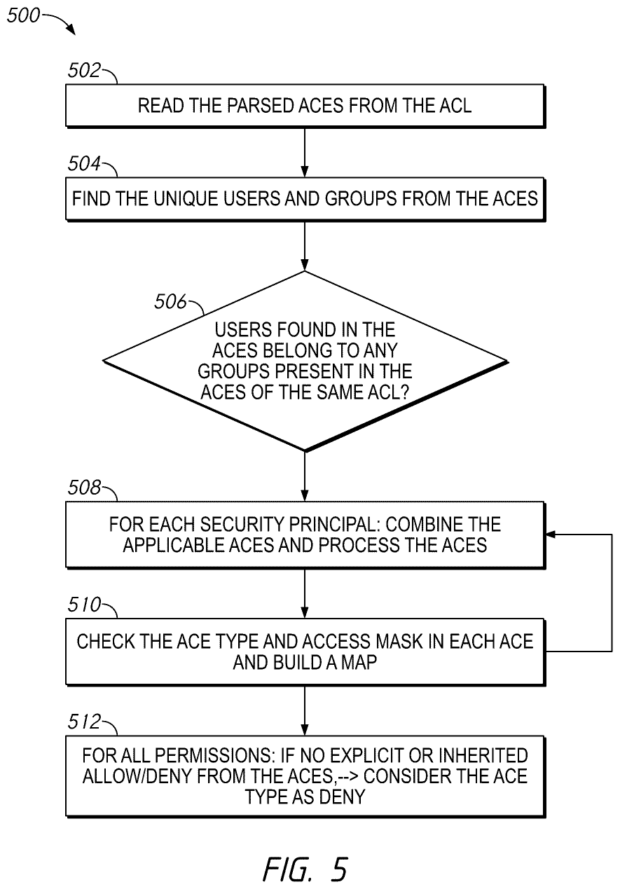

FIG. 5 is a flowchart of a method 500 for evaluating ACLs into effective permissions in accordance with examples described herein. In some examples, the method 500 may be performed in the block 326 of FIG. 3. The method 500 includes block 502 which recites “read the parsed ACEs from the ACL.” Block 502 may be followed by block 504, “find the unique users and groups from the ACEs.” Block 504 may be followed by decision block 506, “users found in the ACEs belong to any groups present in the ACEs of the same ACL?” Block 506 may be followed by block 508, “for each security principal: combine the applicable ACEs and process the ACEs.” Block 508 may be followed by block 510, “check the ACE type and access mask in each ACE and build a map.” The blocks 508 and 510 may be repeated until the blocks 508 and 510 can be performed for all security principals. Then block 512, “for all permissions: if no explicit or inherited allow/deny from the ACEs,-->consider the ACE type as deny” may follow. As a batch processing, block 512 may be followed by block 502, e.g., the method may be repeated using another time range. The blocks of FIG. 5 are exemplary only. Additional, fewer, and/or different blocks may be used in other examples, and the blocks may be differently ordered in other examples.

The method 500 of FIG. 5 may be performed, for example, by one or more components of the analytics system 400 described herein. For example, the event processor 410 of the analytics system 400 of FIG. 4 may perform the method 500. The event processor 410 may be implemented using executable instructions stored on computer readable media, which, when executed by one or more processor(s), perform ACL evaluation in accordance with the method 500. Similarly, the event processor 224 of the analytics systems 216 of FIG. 2 or the event processor 310 of FIG. 3 may perform the method 500. The event processor 224 or the event processor 310 may include executable instructions stored on computer readable media, which, when executed by one or more processor(s), perform ACL evaluation in accordance with method 500.

In block 502, the parsed ACEs from the ACL, such as the ACL blob as parsed in block 326 in FIG. 3 may be read. For example, the event processor 410 of FIG. 4 may read the ACEs while maintaining the order of the ACEs. In some examples, the event processor 410 may find unique users and groups from the ACEs in block 504. In block 506, the event processor 410 may check if the users found in the ACEs belong to any groups present in the ACEs of the same ACL. For each security principal (e.g., user/group) found in the ACEs, the applicable ACEs may be combined, and the event processor 410 may process the combined ACEs in block 508. In block 508, the ACEs have been added to the ACL in a canonical order, and the same order may be maintained while reading the ACL; the ACEs can be processed sequentially for each user/group. In block 510, the event processor 410 may check the ACE type and access mask in each ACE. Based on the ACE type and access masks, such as granular permissions, the event processor 410 may build a map for all permissions. The blocks 508 and 510 may be repeated until the blocks 508 and 510 may be performed for all security principals. In block 512, at the end of processing all ACEs, each permission's status may be determined as either “allow” or “deny.” If there is any permission without explicit or inherited status of either allow or deny from the ACEs, the ACE type may be considered as “deny.” Permissions for shares may or may not be considered separately for evaluation since these permissions are likely to be included in the ACL.

In some examples, during the process of ACL evaluations, various kinds of failures may be encountered. Accordingly, errors may be reported by the analytics system 400 through its user interface, such as the user interface 236 of FIG. 2 or the user interface 314 of FIG. 3 described herein. In some examples, the event processor 410 may calculate a risk metric based on the evaluations of ACLs as well as the failures. It may not be feasible for a manual administrator to identify the risk based on a vast number of ACL blobs for files, active directories, or shares; for example, there may be millions of files on the file server. Examples of file analytics systems described herein may assist in identifying active directories or shares which are at a higher risk based on their ACLs, based on batch processing of updating permission statuses. For example, the effective permissions table 418 and the static permissions table 420 of the datastore 406 may be updated as there is a change in the ACLs, without a user's explicit request or command to obtain the ACLs from the file server, such as the file server 160 of FIG. 1, the file server 202 of FIG. 2, or the file server 302 of FIG. 3. Thus, even when such file server is down or unavailable to the analytics system or other system, the effective permissions table 418 and the static permissions table 420 may be available for risk analysis based on access control statuses provided while such file server was active.

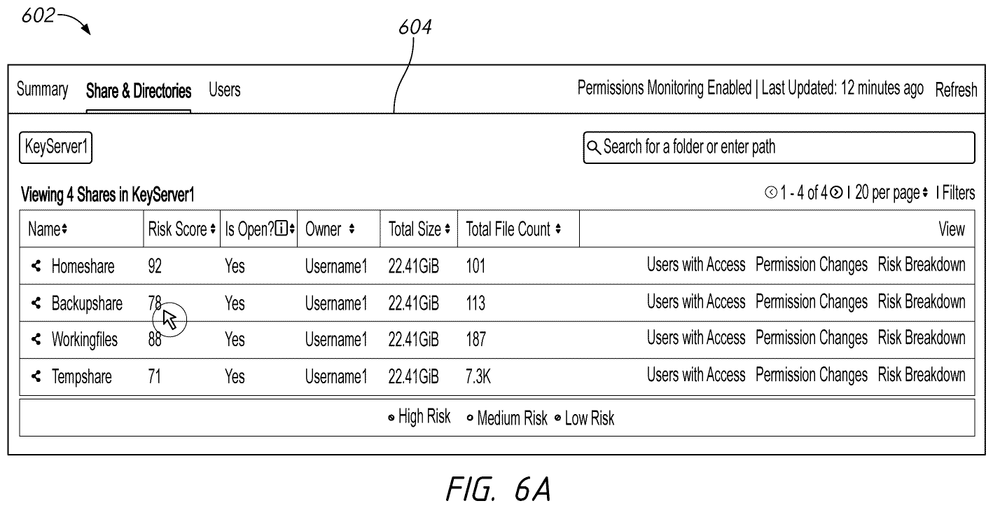

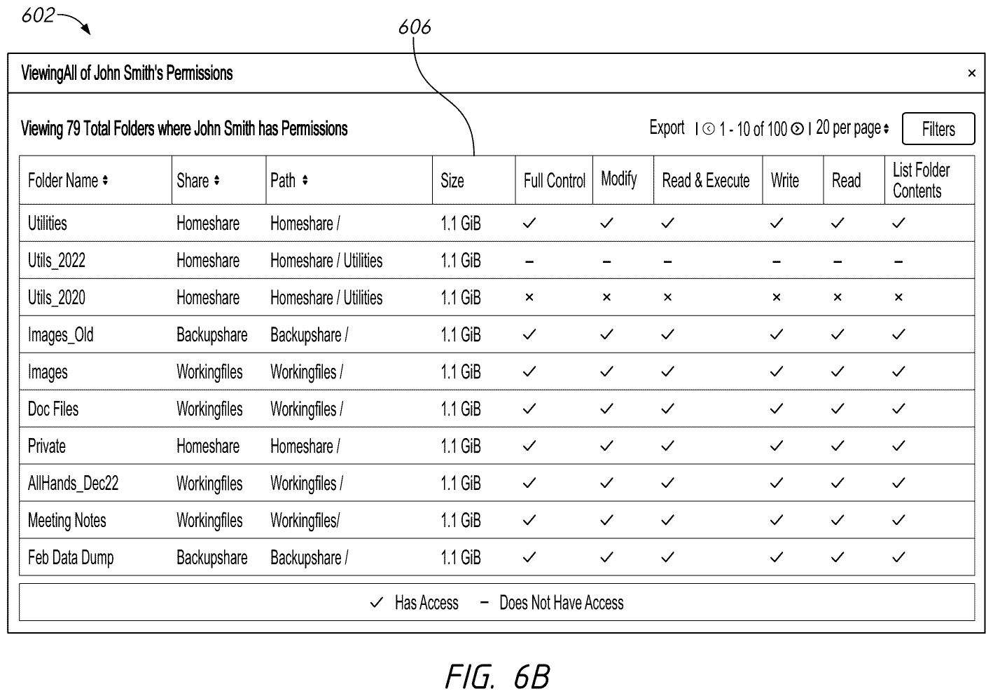

FIGS. 6A-6B are schematic illustrations of an example user interface display which may be generated in part by analytics systems described herein. FIG. 6A is a schematic illustration of the user interface 602. The user interface 602 may be wholly and/or partially implemented using user interface 236 of FIG. 2 and/or user interface 314 of FIG. 3 in some examples. Examples of user interfaces described herein may display a table 604 of FIG. 6A, listing shares of a file server “KeyServer1.” The table 604 may be a summary listing a risk score, open access status, an owner, a total size and a total file count for each share. In the example of FIG. 6A, names of the shares are shown in the leftmost column of the table 604. For each share, the table 604 allows a user to view users with access, permission changes, and risk breakdown by clicking respective text strings, such as “Users with Access,” “Permission Changes” or “Risk Breakdown,” for example. The table 604 may further include an indication of a risk level (high/medium/low) based on a calculated risk value. The table 604 of FIG. 6A is exemplary only—additional, fewer, or other data may be displayed in other examples.

FIG. 6B is a schematic illustration of the user interface 602. Examples of user interfaces described herein may display a table 606 of FIG. 6B, listing folders and shares that an example user “John Smith” has permissions. The table 606 may be a summary of folders, shares, size of folders, and various access control statuses such as “full control, modify, read and execute, write, read, list folder contents” determined by the user. The table 606 of FIG. 6B is exemplary only—additional, fewer, or other data may be displayed in other examples.

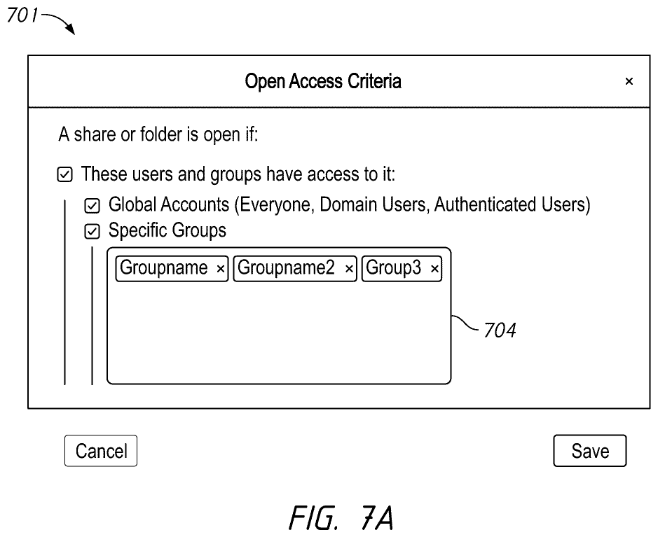

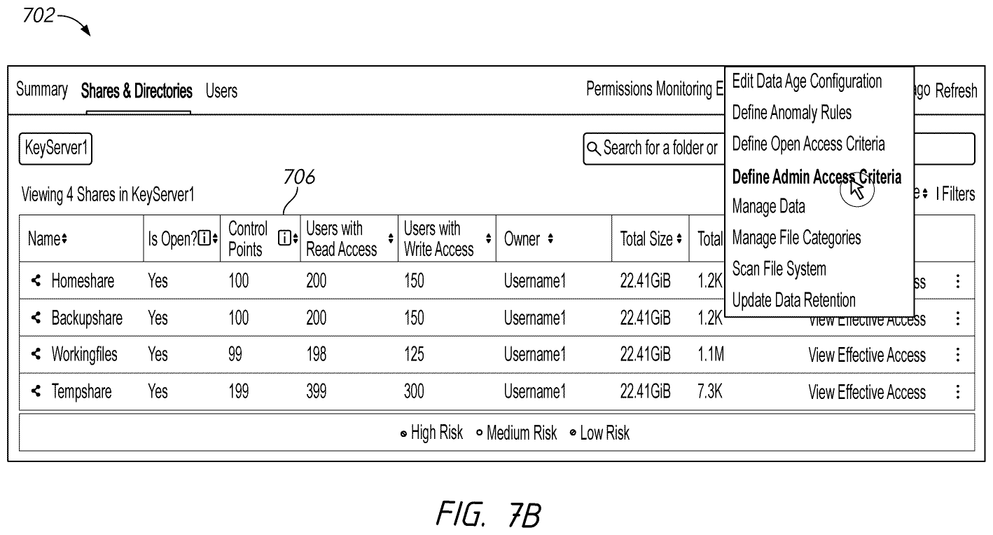

FIGS. 7A-7B are schematic illustrations of an example user interface display which may be generated in part by analytics systems described herein. FIG. 7A is a schematic illustration of a window 701 in an example user interface display caused by a user interface 702. The user interface 702 may wholly and/or partially implement using user interface 236 of FIG. 2 and/or user interface 314 of FIG. 3 in some examples. The window 701 may include a prompt display 704 of open access criteria. The window 701 of FIG. 7A is exemplary only—additional, fewer, or other data may be displayed in other examples.

In some examples, the prompt display 704 of the window 701 may allow a user to enter one or more specific group names and save these group names as open access criteria by clicking a save button, in addition to global accounts.

FIG. 7B is a schematic illustration of the user interface 702. Examples of user interfaces described herein may display a table 706 listing shares and directories. The table 706 may be a summary of read/write access of users within the specific groups. In the example of FIG. 7B, names of the shares and directories are shown in the leftmost column of the table 706. For each share or each directory, the table 706 allows a user to view effective access by clicking on “View Effective Access.” The table 706 may further depict an owner, a total size, and a total file count of the share or directory. The table 706 may further include an indication of a risk level (high/medium/low) for each share based on a calculated risk value. The table 706 of FIG. 7B is exemplary only—additional, fewer, or other data may be displayed in other examples.

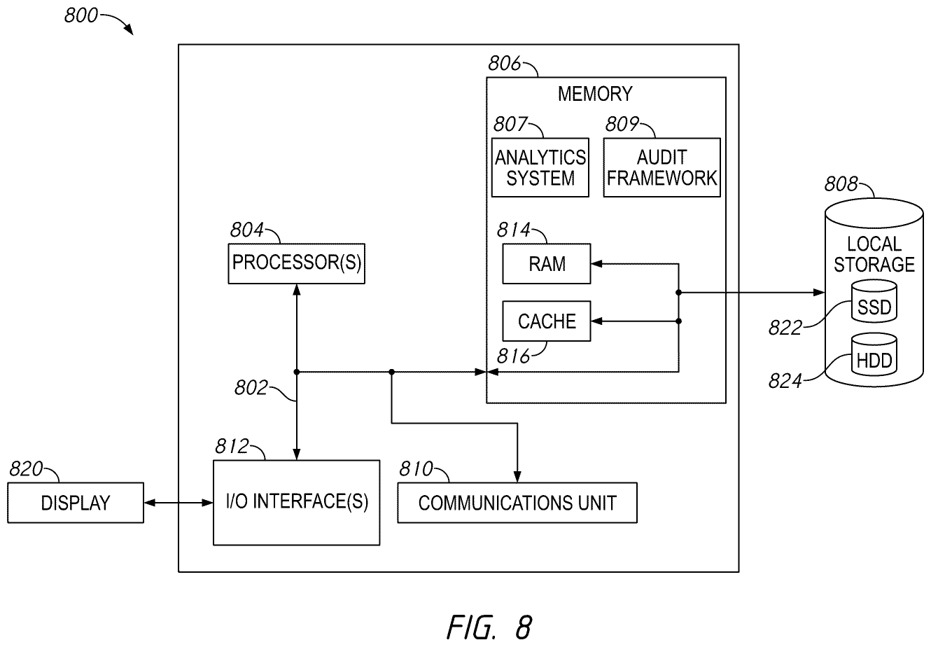

FIG. 8 depicts a block diagram of components of a computing node (e.g., computing device or computing system) 800 in accordance with embodiments of the present disclosure. It should be appreciated that FIG. 8 provides only an illustration of one implementation and does not imply any limitations with regard to the environments in which different embodiments may be implemented. Many modifications to the depicted environment may be made. The computing node 800 may be implemented as at least part of the file server 160 of FIG. 1A, file server 202 of FIG. 2, analytics system 216 of FIG. 2, and/or any other computing device and/or system described herein. In some examples, the computing node 800 may be a standalone computing node or part of a cluster of computing nodes configured to host a distributed file server (e.g., any of the file server virtual machines described herein).

The computing node 800 includes a communications fabric 802, which provides communications between one or more processor(s) 804, memory 806, local storage 808, communications unit 810, and I/O interface(s) 812. The communications fabric 802 can be implemented with any architecture designed for passing data and/or control information between processors (such as microprocessors, communications and network processors, etc.), system memory, peripheral devices, and any other hardware components within a system. For example, the communications fabric 802 can be implemented with one or more buses.

The memory 806 and the local storage 808 are non-transitory computer-readable storage media. In this embodiment, the memory 806 includes random access memory (RAM) 814 and cache 816. In general, the memory 806 can include any suitable volatile or non-volatile computer-readable storage media. In an embodiment, the local storage 808 includes an SSD 822 and an HDD 824.

Various computer instructions, programs, files, images, etc. may be stored in local storage 808 for execution by one or more of the respective processor(s) 804 via one or more memories of memory 806. In some examples, local storage 808 includes a magnetic HDD 824. Alternatively, or in addition to a magnetic hard disk drive, local storage 808 can include the SSD 822, a semiconductor storage device, a read-only memory (ROM), an erasable programmable read-only memory (EPROM), a flash memory, or any other computer-readable storage medium that is capable of storing program instructions or digital information.

The media used by local storage 808 may also be removable. For example, a removable hard drive may be used for local storage 808. Other examples include optical and magnetic disks, thumb drives, and smart cards that are inserted into a drive for transfer onto another computer-readable storage medium that is also part of local storage 808. The local storage may be configured to store executable instructions for an analytics system 807 and/or executable instructions for an audit framework 809. The analytics system 807 may perform operations described with reference to the analytics system 216 and/or analytics system 400 in some examples. The audit framework 809 may perform operations described with reference to the audit framework of the file server 202 of FIG. 2 and/or the audit framework 208 in some examples. In some examples, the memory 806 may be encoded with executable instructions for a query engine 242, an event processor as described herein, such as an event processor 224, event processor 310, and/or event processor 410. In some examples, the computing node 800 may host one or more virtual machines and/or containers described herein.

Communications unit 810, in these examples, provides for communications with other data processing systems or devices. In these examples, communications unit 810 includes one or more network interface cards. Communications unit 810 may provide communications through the use of either or both physical and wireless communications links.

I/O interface(s) 812 allows for input and output of data with other devices that may be connected to computing node 800. For example, I/O interface(s) 812 may provide a connection to external device(s) such as a keyboard, a keypad, a touch screen, and/or some other suitable input device. External device(s) can also include portable computer-readable storage media such as, for example, thumb drives, portable optical or magnetic disks, and memory cards. Software and data used to practice embodiments of the present disclosure can be stored on such portable computer-readable storage media and can be loaded onto local storage 808 via I/O interface(s) 812. I/O interface(s) 812 also connect to a display 820.

Display 820 provides a mechanism to display data to a user and may be, for example, a computer monitor. In some examples, a GUI associated with the user interface 236 of FIG. 2, user interface 314 of FIG. 3, user interface 602 or user interface 702 may be presented on the display 820.

Example data analytics systems described herein may receive ACLs regarding files across a VFS hosted on a cluster of computing nodes, and may monitor permissions for SMB shares and active directories. Such example data analytics systems may calculate risk against such shares and generate reports for metrics related to permissions. The example data analytics systems may assist finding permissions-related risk areas, emphasis on data that is useful in permission management decisions, or risk assessment by informing users risk profile and permission details of for any file server, share or directory and/or permission details for any user or user group over any directory or share to aid in remediation. This effective permission evaluation without active connection is particularly helpful in case of anomaly or forensic analysis. For example, when a file server is down, the system can still perform forensic analysis and/or recovery on effective permissions, because the system can function without either active connection to file server, or administrator credentials for active directories.

From the foregoing it will be appreciated that, although specific embodiments have been described herein for purposes of illustration, various modifications may be made while remaining with the scope of the claimed technology.

Examples described herein may refer to various components as “coupled” or signals as being “provided to” or “received from” certain components. It is to be understood that in some examples the components are directly coupled one to another, while in other examples the components are coupled with intervening components disposed between them. Similarly, signals or communications may be provided directly to and/or received directly from the recited components without intervening components, but also may be provided to and/or received from the certain components through intervening components.

What is claimed is:

1. A method comprising:
receiving, at an analytics system, an access control list of a storage item in a file server responsive to a change to data in the storage item, the access control list including access control entries;
evaluating effective permission of the access control list based on an active directory;
detecting a change in either one or more permissions or one or more memberships of the storage item in the active directory;
re-evaluating, at the analytics system, the effective permission of the access control list upon detecting the change;
storing the effective permission in a data repository of the analytics system; and
accessing the effective permission at the data repository during a time the file server is unavailable to the analytics system.

2. The method of claim 1, wherein the file server is included in a virtualized file system including a plurality of computer nodes.

3. The method of claim 1, further comprising:
requesting group membership information to the file server; and
receiving group membership information for the active directory from the file server.

4. The method of claim 3, wherein evaluating effective permission of the access control list based on the active directory comprises calculating effective permission based on relationship between a group and one or more users indicated in the group membership information.

5. The method of claim 1, further comprising requesting an access control list for an active control list identifier to the file server.

6. The method of claim 5, wherein the requesting the access control list is executed periodically.

7. The method of claim 1, wherein the analytics system comprises a user interface.

8. The method of claim 7, further comprising presenting information related to the effective permission from the user interface during a time the file server is unavailable to the analytics system.

9. The method of claim 7, wherein the requesting the access control list is executed responsive to a user request from the user interface.

10. At least one non-transitory computer readable medium encoded with instructions which, when executed, cause a system to perform operations comprising:
receiving, at an analytics system, an access control list of a storage item in a file server responsive to a change to data in the storage item, the access control list including access control entries;
evaluating effective permission of the access control list based on an active directory;
detecting a change in either one or more permissions or one or more memberships of the storage item in the active directory;
re-evaluating, at the analytics system, the effective permission of the access control list upon detecting the change;
storing the effective permission in a data repository of the analytics system; and
accessing the effective permission at the data repository during a time the file server is unavailable to the analytics system.

11. The non-transitory computer readable medium of claim 10, wherein the file server is included in a virtual file system including file servers.

12. The non-transitory computer readable medium of claim 10, wherein the operations further comprise:
requesting group membership information to the file server; and
receiving group membership information for the active directory from the file server.

13. The non-transitory computer readable medium of claim 12, wherein evaluating effective permission of the access control list based on the active directory comprises calculating effective permission based on relationship between a group and one or more users indicated in the group membership information.

14. The non-transitory computer readable medium of claim 10, wherein the operations further comprise requesting an access control list for an active control list identifier to the file server.

15. The non-transitory computer readable medium of claim 14, wherein the requesting the access control list is executed periodically.

16. The non-transitory computer readable medium of claim 10, wherein the analytics system comprises a user interface.

17. The non-transitory computer readable medium of claim 16, wherein the operations further comprise presenting information related to the effective permission from the user interface during a time the file server is unavailable to the analytics system.

18. The non-transitory computer readable medium of claim 16, wherein the requesting the access control list is executed responsive to a user request from the user interface.

19. A system comprising:
a file server including a virtualized file system, the file server including a plurality of computer nodes; and
an analytics system comprising a data repository, the analytics system configured to:
receive an access control list of a storage item in the file server responsive to a change to data in the storage item, the access control list including access control entries;
evaluate effective permission of the access control list based on an active directory;
detect a change in either one or more permissions or one or more memberships of the storage item in the active directory;
re-evaluate the effective permission of the access control list upon detecting the change;
store the effective permission in the data repository; and
access the effective permission at the data repository during a time the file server is unavailable to the analytics system.

20. The system of claim 19, wherein the analytics system further comprises an event processor configured to evaluate the effective access of the access control list based on the active directory and further configured to provide one or more permissions tables to the data repository.

21. The system of claim 19, wherein the analytics system is further configured to receive group membership information for the active directory from the file server, and
wherein the analytics system is configured to calculate the effective permission based, at least in part, on relationship between a group and one or more users indicated in the group membership information.

22. The system of claim 19, further comprising a user interface,
wherein the analytics system is configured to cause the user interface to present information related to the effective permission during a time the file server is unavailable to the analytics system.

23. The system of claim 19, further comprising a batch processor configured to cause the analytics system to request an access control list for an active control list identifier to the file server periodically.
